(19) United States
(12) Patent Application Publication
(10) Pub. No.: US 2024/0320830 A1
(43) Pub. Date: Sep. 26, 2024

(54) METHODS AND APPARATUS FOR DETECTING PLANT DISEASE IN AN AREA

(71) Applicant: GEOSAT Aerospace & Technology Inc., Tainan City (TW)

(72) Inventors: Cheng-Fang LO, Tainan City (TW); Kuang-Yu CHEN, Tainan City (TW)

(21) Appl. No.: 18/189,168

(22) Filed: Mar. 23, 2023

(51) Int. Cl. G06T 7/00

(52) U.S. Cl. CPC G06T 7/0014; G06T 2207/10024; G06T 2207/10036; G06T 2207/10048; G06T 2207/30188

(57) ABSTRACT

Methods and apparatus for detecting plant disease in an area, the apparatus including a memory storing instructions and at least one processor configured to execute the instructions to perform operations including: obtaining a plurality of multispectral aerial images corresponding to a plurality of plants, obtaining one or more template images of one or more sample plants, and determining whether plant disease exists in the plurality of plants based on the multispectral aerial images and the one or more template images.

### TECHNICAL FIELD

The present disclosure relates to detecting plant disease, and more particularly, to methods and apparatus for detecting plant disease in an area.

### BACKGROUND

Farmworkers or professionals usually need to walk to each of a plurality of plants in an area, observe the plurality of plants with their own eyes, and determine whether plant disease exists on any of the plurality of plants. However, this is challenging and time-consuming when a substantial number of plants over a considerable area need to be observed and diagnosed. Moreover, another challenge is how all different farmworkers or professionals observe and determine whether plant disease exists on the plurality of plants based on the same or at least similar standards.

### SUMMARY

Embodiments of the present application provide methods and apparatus for detecting plant disease in an area.

These embodiments include apparatus for detecting plant disease in an area. The apparatus includes a memory storing instructions and at least one processor configured to execute the instructions to perform operations including obtaining a plurality of multispectral aerial images corresponding to a plurality of plants, obtaining one or more template images of one or more sample plants, and determining whether plant disease exists in the plurality of plants based on the multispectral aerial images and the one or more template images.

These embodiments also include a non-transitory computer-readable medium storing instructions which, when executed, cause one or more processors to perform operations for detecting plant disease in an area. The operations include obtaining a plurality of multispectral aerial images corresponding to a plurality of plants, obtaining one or more template images of one or more sample plants, and determining whether plant disease exists in the plurality of plants based on the multispectral aerial images and the one or more template images.

These embodiments further include a method for detecting plant disease in an area. The method includes obtaining a plurality of multispectral aerial images corresponding to a plurality of plants, obtaining one or more template images of one or more sample plants, and determining whether plant disease exists in the plurality of plants based on the multispectral aerial images and the one or more template images.

It is to be understood that the foregoing general description and the following detailed description are exemplary and explanatory only, and are not restrictive of the invention, as claimed.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of exemplary apparatus for detecting plant disease in an area, according to some embodiments of the present disclosure.

FIG. 2 is a flow chart of an exemplary method for detecting plant disease in an area, according to some embodiments of the present disclosure.

FIG. 3 is an exemplary annotated color aerial photograph of an area for detecting plant disease, according to some embodiments of the present disclosure.

FIG. 4 is a color representation of an exemplary annotated optimized soil-adjusted vegetation index (OSAVI) image of an area for detecting plant disease, according to some embodiments of the present disclosure.

FIG. 5 illustrates a color representation of an exemplary annotated OSAVI sub-image, an exemplary annotated color aerial photograph, and three exemplary color side-view photographs of healthy oil palm trees within a subarea for detecting plant disease, according to some embodiments of the present disclosure.

FIG. 6 illustrates a color representation of an exemplary annotated OSAVI sub-image, an exemplary annotated color aerial photograph, and three exemplary color side-view photographs of Ganoderma-infected oil palm trees within a subarea for detecting plant disease, according to some embodiments of the present disclosure.

FIG. 7 illustrates color representations of OSAVI images of exemplary oil palm trees in a subarea for detecting plant disease, according to some embodiments of the present disclosure.

FIG. 8 illustrates color representations of OSAVI images of exemplary oil palm trees in a subarea for detecting plant disease, according to some embodiments of the present disclosure.

FIG. 9 illustrates an exemplary table summarizing appearances of the oil palm trees shown in FIG. 7, according to some embodiments of the present disclosure.

FIG. 10 illustrates an exemplary table summarizing appearances of the exemplary oil palm trees shown in FIG. 8, according to some embodiments of the present disclosure.

FIG. 11 illustrates an exemplary table of leaf chlorophyll content and moisture of the exemplary oil palm trees in subarea Z1 shown in FIG. 7, according to some embodiments of the present disclosure.

FIG. 12 illustrates an exemplary table of leaf chlorophyll content and moisture of the exemplary oil palm trees in subarea Z2 shown in FIG. 8, according to some embodiments of the present disclosure.

FIG. 13 is a flow chart of an exemplary method for detecting plant disease in an area, according to some embodiments of the present disclosure.

FIG. 14 is a flow chart of an exemplary method for detecting plant disease in an area, according to some embodiments of the present disclosure.

FIG. 15 is a flow chart of an exemplary method for detecting plant disease in an area, according to some embodiments of the present disclosure.

### DETAILED DESCRIPTION

This disclosure is generally directed to methods and apparatus for detecting plant disease in an area. It is contemplated that a plant can be an oil palm tree, a rice plant, a fruit tree, a crop plant, or any combination thereof. A plant disease to be detected can be any of plant diseases that change one or more features of a plant, such as Ganoderma disease on an oil palm tree that changes one or more features of the oil palm tree. The plant disease to be detected causes one or more feature changes, such as changes in color, shape, and/or appearance, of the plant. These feature changes of the plant are utilized for detecting the plant disease on plants in an area of interest.

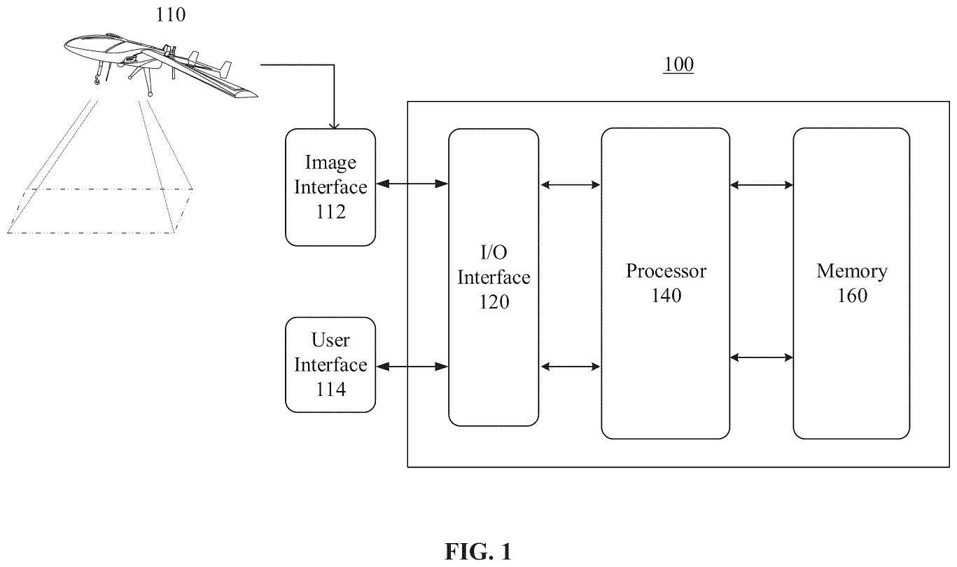

FIG. 1 is a block diagram of exemplary apparatus 100 for detecting plant disease in an area, according to some embodiments of the present disclosure. As shown in FIG. 1, apparatus 100 includes an input/output (I/O) interface 120, a processor 140, and a memory 160. Processor 140 is coupled to I/O interface 120 to input and/or output data from/to external components, such as an image interface 112 and a user interface 114. Processor 140 is also coupled to memory 160 to access data for detecting plant disease. These elements of apparatus 100 may be configured to transfer data and send or receive instructions and signals between or among each other.

I/O interface 120 is coupled with processor 140 to provide input and output data, such as aerial images and data, plant data, disease information, user instructions and/or data, and information to be displayed. For example, as shown in FIG. 1, an unmanned aerial vehicle (UAV) 110 is configured to take color aerial photographs and multispectral aerial images of an area of interest, collect aerial data, and provide the color aerial photographs, multispectral aerial images, and aerial data via image interface 112 to apparatus 100. I/O interface 120 is coupled to image interface 112 and configured to receive the color aerial photographs, multispectral aerial images, and aerial data from UAV 110 via image interface 112 for apparatus 100 to detect plant disease in the area of interest. As shown in FIG. 1, I/O interface 120 is also coupled to user interface 114 and configured to provide information to be displayed for a user and/or receive input data and instructions from the user and/or external equipment. In this way, apparatus 100 can be configured to display information to and/or receive instructions and data from the user and/or external equipment via user interface 114.

Processor 140 includes any appropriate type of one or more general-purpose or special-purpose microprocessors, digital signal processors, artificial intelligence processors, and/or microcontrollers. Processor 140 can be configured by one or more programs stored in memory 160 to perform operations with respect to the methods and apparatus illustrated and described herein.

Memory 160 includes any appropriate type of mass storage provided to store any type of information that processor 140 may need to operate. Memory 160 may include one or more of a volatile or non-volatile, magnetic, semiconductor, tape, optical, removable, non-removable, or other type of storage device or tangible (i.e., non-transitory) computer-readable medium including, but not limited to, a read-only memory (ROM), a flash memory, a dynamic random-access memory (RAM), and a static RAM. Memory 160 may be configured to store one or more programs for execution by processor 140 for detecting plant disease, as disclosed herein. Memory 160 may be further configured to store information and data received from UAV 110 via image interface 112, measurement results received via user interface 114, and/or images and data used, calculated, and/or generated by processor 140. For example, memory 160 may be configured to store received RGB aerial images, multispectral aerial images, image data in red, green, blue, read edge, and near-infrared bands, cropped multispectral aerial images, side-view images, values of chlorophyll b, calculated vegetation indices, a plurality of template images, a plurality of disease thresholds and/or match thresholds, and detection results.

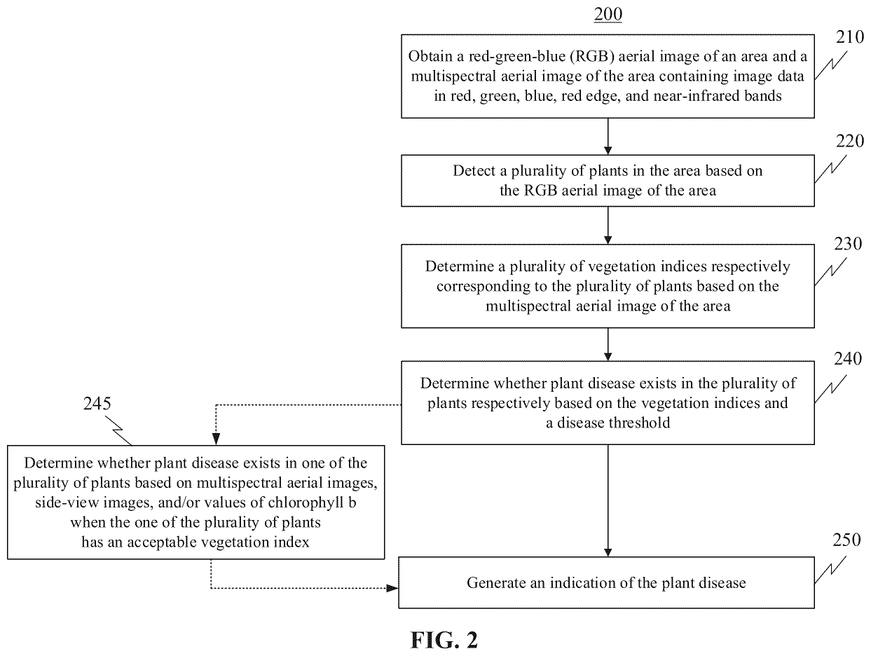

FIG. 2 is a flow chart of an exemplary method 200 for detecting plant disease in an area, according to some embodiments of the present disclosure. Method 200 may be practiced by apparatus 100 for detecting plant disease. Solely for illustrative purposes and without limitation, method 200 is described with reference to an example of detecting disease in oil palm trees. However, method 200 practiced by apparatus 100 is not so limited and can be implemented to detect plant disease in other types of plants. Method 200 includes obtaining a red-green-blue (RGB) aerial image of an area and a multispectral aerial image of the area containing image data in red, green, blue, red edge, and near-infrared bands (step 210); detecting a plurality of plants in the area based on the RGB aerial image of the area (step 220); determining a plurality of vegetation indices respectively corresponding to the plurality of plants based on the multispectral aerial image of the area (step 230); determining whether plant disease exists in the plurality of plants respectively based on the plurality of vegetation indices and a disease threshold (step 240); and generating an indication of the plant disease (step 250). Optionally, method 200 may further include determining whether plant disease exists in one of the plurality of plants based on multispectral aerial images, side-view images, and/or values of chlorophyll b when the one of the plurality of plants has an acceptable vegetation index (step 245). When method 200 includes step 245, step 250 is performed after step 245.

Step 210 includes obtaining an RGB aerial image of the area and a multispectral aerial image of the area containing image data in red, green, blue, red edge, and near-infrared bands. For example, UAV 110 can be configured to capture a plurality of color aerial photographs of an area by a camera and a plurality of multispectral aerial images of the area by a multispectral camera. The plurality of multispectral aerial images of the area contain image data, such as reflectance in red, green, blue, red edge, and near-infrared bands. Processor 140 of apparatus 100 can also be configured to receive the plurality of color aerial photographs and the plurality of multispectral aerial images via I/O interface 120 and image interface 112, from UAV 110. Processor 140 can be further configured to stitch the plurality of color aerial photographs together to obtain a color aerial photograph of the area, i.e., the RGB aerial image of the area, and to stitch the plurality of multispectral aerial images together to obtain the multispectral aerial image of the area. Processor 140 can be further configured to store the RGB aerial image of the area and/or the multispectral aerial image of the area in memory 160.

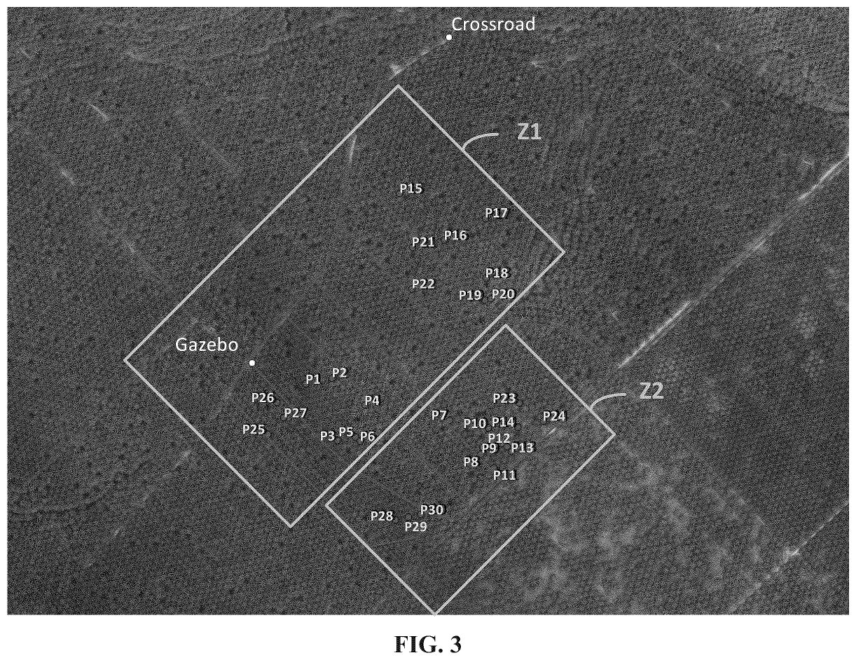

FIG. 3 is an exemplary annotated color aerial photograph of an area for detecting plant disease, according to some embodiments of the present disclosure. As shown in FIG. 3, the color aerial photograph of the area includes a plurality of oil palm trees in the area. Among the plurality of oil palm trees in the area, thirty oil palm trees P1-P30 are marked by dots as exemplary oil palm trees herein. The oil palm trees P1-P30 are located in subareas Z1 and Z2, delineated in FIG. 3. The annotated color aerial photograph of the area contains two reference locations, Gazebo and Crossroad.

When UAV 110 is configured to take the plurality of color aerial photographs of an area, UAV 110 is also configured to record its instant global positioning system (GPS) positions. When processor 140 is configured to receive the plurality of color aerial photographs of the area from UAV 110, processor 140 is also configured to receive the instant GPS positions of the plurality of color aerial photographs from UAV 110. When processor 140 is configured to stitch the plurality of color aerial photographs into the color aerial photograph of the area in FIG. 3, processor 140 is also configured to calculate GPS positions of all image pixels of the color aerial photograph of the area based on the received GPS positions of the plurality of color aerial photographs and a map database of the area. Since the color aerial photograph in FIG. 3 is represented in RGB color codes in apparatus 100, it is also referred to as the RGB aerial image of the area in the present disclosure. That is, “photograph” and “image” are used interchangeably in the present disclosure.

Step 220 includes detecting a plurality of plants in the area based on the RGB aerial image of the area. For example, processor 140 of apparatus 100 is configured to detect a plurality of oil palm trees in the RGB aerial image of the area in FIG. 3 based on top views of oil palm trees. Processor 140 is also configured to obtain GPS positions of the detected oil palm trees in the RGB aerial image of the area. In this way, processor 140 can be configured to identify those detected oil palm trees correspondingly in the multispectral image of the area based on the GPS positions.

Step 230 includes determining a plurality of vegetation indices respectively corresponding to the plurality of plants based on the multispectral aerial image of the area. For example, in accordance with the image data of the multispectral aerial image of the area obtained in step 210, processor 140 of apparatus 100 is configured to determine, e.g., by calculating, a plurality of optimized soil adjusted vegetation indices (OSAVIs) respectively corresponding to the plurality of detected oil palm trees detected in step 220 based on an OSAVI formula,

$$OSAVI = \frac{( 1 + L ) ( NIR - Red )}{NIR + Red + L} ,$$

where NIR is a reflectance in the near-infrared band, Red is a reflectance in the red band, and Lis a canopy background adjustment parameter. As an example, L=0.16 is used to calculate the plurality of OSAVIs respectively corresponding to the plurality of oil palm trees detected in step 220.

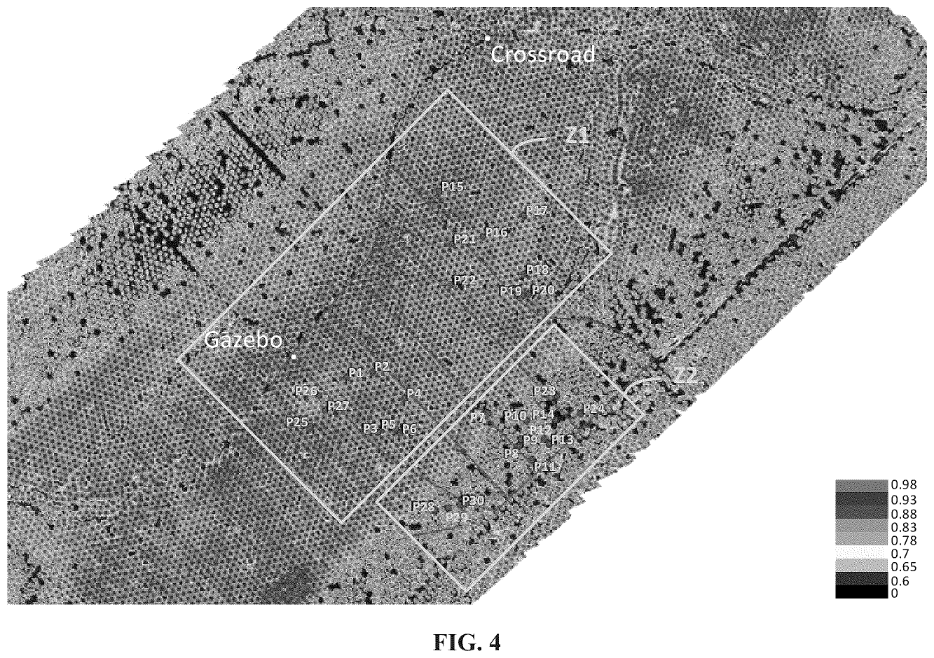

FIG. 4 is a color representation of an exemplary annotated OSAVI image of the area shown in FIG. 3 for detecting plant disease, according to some embodiments of the present disclosure. As described above in step 210, processor 140 of apparatus 100 is configured to obtain the multispectral aerial image of the area and the multispectral image of the area contains image data in red, green, blue, red edge, and near-infrared bands. The multispectral image of the area is not shown herein. As described above in step 230, processor 140 is also configured to calculate the OSAVIs respectively corresponding to the plurality of oil palm trees using the OSAVI formula and the image data of the multispectral image in red, green, blue, red edge, and near-infrared bands. Processor 140 is further configured to represent the OSAVIs corresponding to the pixels of the multispectral aerial image of the area by an arbitrary set of colors shown in a legend in FIG. 4, to form the OSAVI image of the area in FIG. 4. The OSAVI image of the area contains the OSAVIs represented by the arbitrary set of colors and may be associated with the image data of the multispectral image in red, green, blue, red edge, and/or near-infrared bands based on the OSAVI formula above.

As shown in FIG. 4, the OSAVI image also contains the reference locations Gazebo and Crossroad and exemplary oil palm trees P1-P30 located in subareas Z1 and Z2, corresponding to those in the RGB aerial image of the area in FIG. 3. Because the OSAVI formula above includes parameters in red and near-infrared bands, the OSAVI image of the area in FIG. 4 is also a multispectral aerial image of the area.

Step 240 includes determining whether plant disease exists in the plurality of plants respectively based on the plurality of vegetation indices and a disease threshold. For example, processor 140 of apparatus 100 is configured to determine whether plant disease exists in each of the plurality of detected oil palm trees based on the plurality of OSAVIs respectively corresponding to the detected oil palm trees and an OSAVI disease threshold. The OSAVI disease threshold could be set with different values for different subareas based on characteristics of the subareas, such as soil fertility. In the present example, the OSAVI disease threshold is set as 0.92 for subarea Z1 and 0.825 for subarea Z2. If an OSAVI of a detected oil palm tree in a subarea is greater than or equal to the OSAVI disease threshold of the subarea, processor 140 is configured to determine that plant disease does not exist in the detected oil palm tree. If the OSAVI of the detected oil palm tree in the subarea is less than the OSAVI disease threshold of the subarea, processor 140 is configured to determine that plant disease exists in the detected oil palm tree.

Step 250 includes generating an indication of the plant disease. For example, processor 140 of apparatus 100 is configured to generate an indication of the plant disease upon determining that plant disease exists in particular ones of the plurality of oil palm trees in the area. The indication includes information that plant disease exists in at least one of the plurality of oil palm trees, and which one(s) of the plurality of oil palm trees has the plant disease.

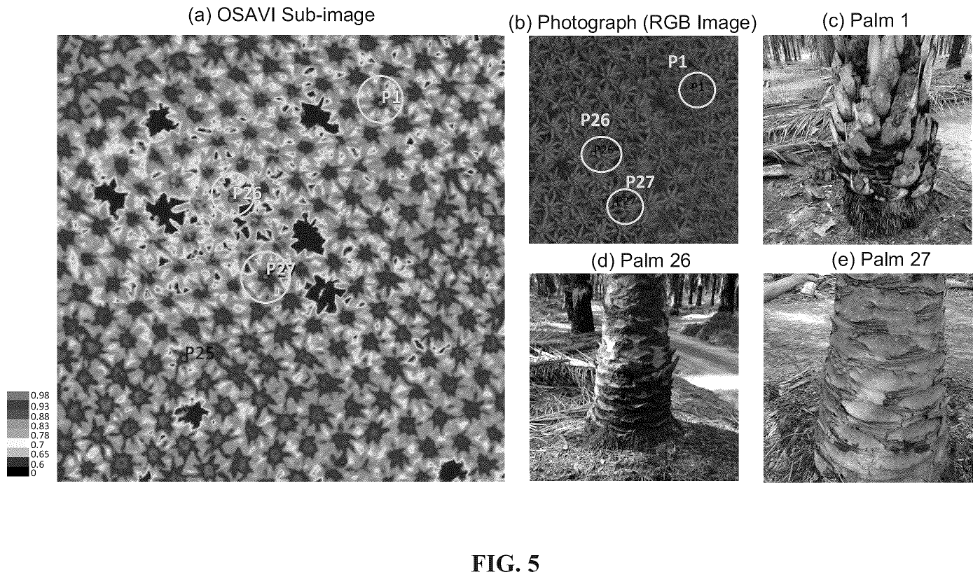

FIG. 5 illustrates a color representation of an exemplary annotated OSAVI sub-image (a), an exemplary annotated color aerial photograph (b), and three exemplary color side-view photographs (c), (d), and (e) of healthy oil palm trees within subarea Z1 for detecting plant disease, according to some embodiments of the present disclosure. The OSAVI sub-image (a) is a portion of subarea Z1 in the OSAVI image of the area in FIG. 4. The annotated color aerial photograph (b) is a portion of the color aerial photograph of the area in FIG. 3 including RGB aerial images of oil palm trees P1, P26, and P27. The three color side-view photographs (c), (d), and (e) illustrate side-view images of oil palm trees P1, P26, and P27. Color aerial photograph (b) and color side-view photographs (c), (d) and (e) in FIG. 5 are represented in RGB color codes in apparatus 100 and therefore also referred to as the RGB aerial image of the area and side-view images in the present disclosure.

In accordance with another embodiment of the present disclosure, processor 140 of apparatus 100 is configured to determine whether plant disease exists in oil palm trees in subarea Z1 by comparing OSAVI images of the oil palm trees in subarea Z1 with one or more OSAVI template images of healthy oil palm trees. For example, processor 140 is configured to obtain, e.g., read from memory 160, an OSAVI image of a healthy oil palm tree as an OSAVI template image. Processor 140 is also configured to calculate match rates between OSAVI images of oil palm trees P1, P26, and P27 and the OSAVI template image. When the OSAVI images of oil palm trees P1, P26, and P27 match the OSAVI template image from the healthy oil palm tree to at least a first predetermined degree (e.g., greater than or equal to a first OSAVI match threshold), processor 140 is configured to determine that plant disease does not exist in oil palm trees P1, P26, and P27. That is, processor 140 is configured to determine that oil palm trees P1, P26, and P27 are healthy. If one of oil palm trees P1, P26, and P27 does not have a match rate to at least the first predetermined degree (e.g., less than the first OSAVI match threshold), processor 140 is configured to determine that plant disease exists in the one of oil palm trees P1, P26, and P27. That is, processor 140 is configured to determine that the one of oil palm trees P1, P26, and P27 is not healthy.

As another example, processor 140 is configured to obtain, e.g., read from memory 160, a plurality of OSAVI images of healthy oil palm trees as a plurality of OSAVI template images. Processor 140 is further configured to calculate match rates between the OSAVI images of oil palm trees P1, P26, and P27 and the plurality of OSAVI template images. When one of oil palm trees P1, P26, and P27 has a match rate with any of the plurality of OSAVI template images to at least a second predetermined degree (e.g., greater than or equal to a second OSAVI match threshold), processor 140 is configured to determine that plant disease does not exist in the one of oil palm trees P1, P26, and P27. That is, processor 140 is configured to determine that the one of oil palm trees P1, P26, and P27 is healthy. If one of oil palm trees P1, P26, and P27 does not have a match rate with any of the plurality of OSAVI template images to at least the second predetermined degree (e.g., less than the second OSAVI match threshold), processor 140 is configured to determine that plant disease exists in the one of oil palm trees P1, P26, and P27. That is, processor 140 is configured to determine that the one of oil palm trees P1, P26, and P27 is not healthy. The first and second predetermined degrees above may be the same or different. The first and second OSAVI match thresholds may be equal, or either of them may be higher than the other.

In accordance with a further embodiment of the present disclosure, processor 140 of apparatus 100 is configured to determine whether plant disease exists in oil palm trees in subarea Z1 by comparing RGB aerial images of the oil palm trees with one or more RGB template images of healthy oil palm trees. For example, processor 140 is configured to crop RGB aerial images of oil palm trees P1, P26, and P27 from image (b) in FIG. 5. Processor 140 is configured to read an RGB aerial image of a healthy oil palm tree from memory 160 as an RGB template image. Processor 140 is configured to calculate match rates between the RGB aerial images of oil palm trees P1, P26, and P27 and the RGB template image. When oil palm trees P1, P26, and P27 have a match rate to at least a first predetermined degree (e.g., greater than or equal to a first RGB match threshold), processor 140 is configured to determine that plant disease does not exist in oil palm trees P1, P26, and P27. That is, processor 140 is configured to determine that oil palm trees P1, P26, and P27 are healthy. If one of oil palm trees P1, P26, and P27 does not have a match rate to at least the first predetermined degree (e.g., less than the first RGB match threshold), processor 140 is configured to determine that plant disease exists in the one of oil palm trees P1, P26, and P27. That is, processor 140 is configured to determine the one of oil palm trees P1, P26, and P27 is not healthy.

As another example, processor 140 is configured to read a plurality of RGB aerial images of healthy oil palm trees from memory 160 as a plurality of RGB template images. Processor 140 is also configured to calculate match rates between the RGB images of oil palm trees P1, P26, and P27 and the plurality of RGB template images. When one of oil palm trees P1, P26, and P27 has a match rate with any of the plurality of RGB template images to at least a second predetermined degree (e.g., greater than or equal to a second RGB match threshold), processor 140 is configured to determine that plant disease does not exist in the one of oil palm trees P1, P26, and P27. That is, processor 140 is configured to determine that the one of oil palm trees P1, P26, and P27 is healthy. If one of oil palm trees P1, P26, and P27 does not have a match rate with any of the plurality of RGB template images to at least the second predetermined degree (e.g., less than the second RGB match threshold), processor 140 is configured to determine that plant disease exists in the one of oil palm trees P1, P26, and P27. That is, processor 140 is configured to determine that the one of oil palm trees P1, P26, and P27 is not healthy. The first and second predetermined degrees may be the same or different. The first and second RGB match thresholds may be equal, or either one of them may be higher than the other.

The manner in which processor 140 calculates a match rate between an OSAVI image or an RGB aerial image of an oil palm tree and a template image is described more fully with reference to equation (1) below.

In some embodiments, an unmanned ground vehicle (UGV) may be configured to take side-view photographs of oil palm trees in the area of FIG. 3. The UGV may also be configured to record all GPS positions corresponding to the side-view photographs of oil palm trees. Processor 140 of apparatus 100 is configured to obtain the side-view photographs of oil palm trees and the corresponding GPS positions from the UGV via image interface 112, and store as side-view images of the oil palm trees in memory 160. Processor 140 is also configured to associate the side-view images of oil palm trees with the detected oil palm trees in step 220 in accordance with the GPS positions recorded by the UGV and UAV 110. For example, processor 140 is configured to determine that a side-view image belongs to oil palm tree P1 if a GPS position corresponding to the side-view image recorded by the UGV is close to a GPS position of oil palm tree P1 recorded by UAV 110, i.e., within an arbitrary distance, e.g., one meter. In this manner, processor 140 obtains the side-view images of the oil palm trees detected in step 220.

In some embodiments, processor 140 of apparatus 100 is configured to determine whether plant disease exists in an oil palm tree based on a side-view image of the oil palm tree. For example, processor 140 may be configured to obtain, e.g., read from memory 160, one or more side-view images of one or more healthy oil palm trees as one or more side-view template images. Processor 140 may also be configured to calculate one or more match rates between a side-view image of an oil palm tree, e.g., oil palm tree P1, and the one or more side-view template images. In this example, if oil palm tree P1 has a match rate to at least a first predetermined degree (e.g., greater than or equal to a first side-view match threshold), processor 140 is configured to determine that plant disease does not exist in oil palm tree P1. That is, processor 140 is configured to determine that oil palm tree P1 is healthy. If oil palm tree P1 does not have any match rate to at least the first predetermined degree (e.g., less than the first side-view match threshold), processor 140 is configured to determine that plant disease exists in oil palm tree P1. That is, processor 140 is configured to determine that oil palm tree P1 is not healthy.

Additionally or alternatively, in some embodiments, processor 140 may be configured to read one or more side-view images of one or more non-healthy oil palm trees as one or more side-view template images from memory 160. For example, the one or more side-view template images may include visual symptoms of Ganoderma disease, such as unopened young leaves, necrosis in older leaves, a skirt-like crown with lower leaves, a white mycelium of Ganoderma, and/or a fruiting body of Ganoderma. Processor 140 may be further configured to calculate one or more match rates between the side-view image of oil palm tree P1 and the one or more side-view template images. When the side-view image of oil palm tree P1 does not match any of the one or more side-view template images that include the visual symptoms of non-healthy oil palm trees, to at least a second predetermined degree (e.g., less than a second side-view match threshold), processor 140 is configured to determine that plant disease does not exist in oil palm tree P1. That is, processor 140 is configured to determine that oil palm tree P1 is healthy. When the side-view image of oil palm tree P1 matches any of the one or more side-view template images including visual symptoms to at least the second predetermined degree (e.g., greater than or equal to the second side-view match threshold), processor 140 is configured to determine that plant disease exists in oil palm tree P1. That is, processor 140 is configured to determine that oil palm tree P1 is not healthy. The first and second predetermined degrees above may be the same or different. The first and second side-view match thresholds may be equal, or either one of them may be higher than the other.

As shown in FIG. 5, side-view photographs (c), (d), and (e) of oil palm trees P1, P26, and P27 are side-view images of healthy oil palm trees. Processor 140 of apparatus 100 is configured to determine that oil palm trees P1, P26, and P27 are healthy by calculating match rates between the side-view images of oil palm trees P1, P26, and P27 and the one or more side-view template images of healthy and/or non-healthy oil palm trees, as described above.

The manner in which processor 140 calculates a match rate between a side-view image of an oil palm tree and a side-view template image of a healthy or non-healthy oil palm tree is described more fully with reference to equation (1) below.

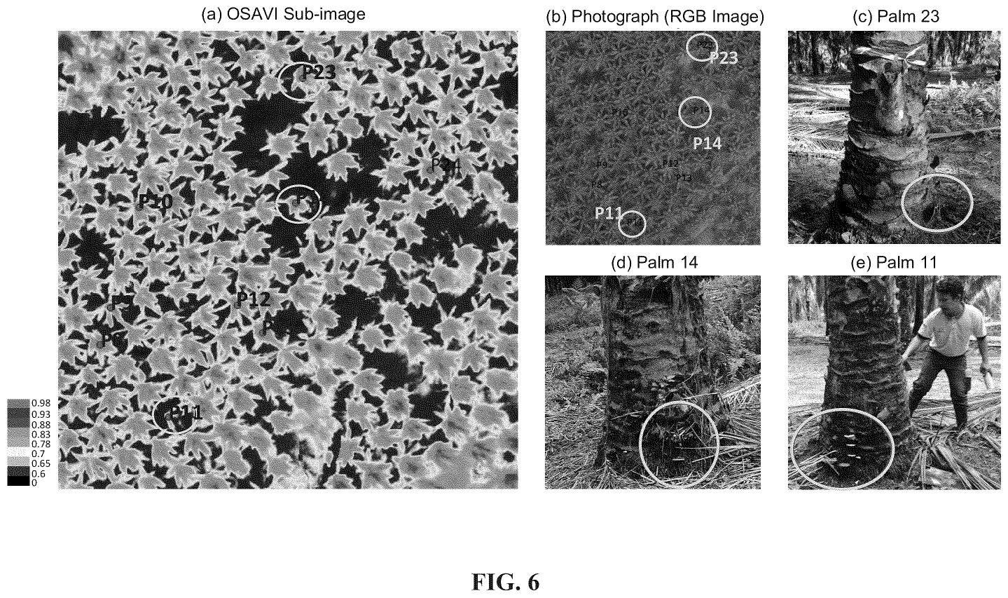

FIG. 6 illustrates a color representation of an exemplary annotated OSAVI sub-image (a), an exemplary annotated color aerial photograph (b), and three exemplary color side-view photographs (c), (d), and (e) of Ganoderma-infected oil palm trees within subarea Z2 for detecting plant disease, according to some embodiments of the present disclosure. The OSAVI sub-image (a) is a portion of the OSAVI image of the area in FIG. 4. The annotated color aerial photograph (b) is a portion of the aerial photograph in FIG. 3 including RGB aerial images of oil palm trees P11, P14, and P23. The three color side-view photographs (c), (d), and (e) illustrate side-view images of oil palm trees P23, P14, and P11, respectively. Color aerial photograph (b) and color side-view photographs (c), (d) and (e) in FIG. 6 are represented in RGB color codes in apparatus 100 and therefore also referred to as the RGB aerial image and side-view images in the present disclosure.

In accordance with another embodiment of the present disclosure, processor 140 of apparatus 100 is configured to determine plant disease exists in oil palm trees in subarea Z2 by comparing OSAVI images of the oil palm trees in subarea Z2 with one or more OSAVI template images of healthy oil palm trees. For example, processor 140 is configured to read an OSAVI image of a healthy oil palm tree from memory 160 as an OSAVI template image. Processor 140 is also configured to calculate match rates between OSAVI images of oil palm trees P11, P14, and P23 and the OSAVI template image. If oil palm trees P11, P14, and P23 have a match rate to at least a third predetermined degree (e.g., greater than or equal to a third OSAVI match threshold), processor 140 is configured to determine that plant disease does not exist in oil palm trees P11, P14, and P23. That is, processor 140 is configured to determine that oil palm trees P11, P14, and P23 are healthy. If one of oil palm trees P11, P14, and P23 does not have a match rate to at least the third predetermined degree (e.g., less than the third OSAVI match threshold), processor 140 is configured to determine that plant disease exists in the one of oil palm trees P11, P14, and P23. That is, processor 140 is configured to determine that the one of oil palm trees P11, P14, and P23 is not healthy.

As another example, processor 140 is configured to obtain, e.g., read from memory 160, a plurality of OSAVI images of healthy oil palm trees as a plurality of OSAVI template images. Processor 140 is configured to calculate match rates between the OSAVI images of oil palm trees P11, P14, and P23 and the plurality of OSAVI template images. If one of oil palm trees P11, P14, and P23 has a match rate with any of the plurality of OSAVI template images to at least a fourth predetermined degree (e.g., greater than or equal to a fourth OSAVI match threshold), processor 140 is configured to determine that plant disease does not exist in the one of oil palm trees P11, P14, and P23. That is, processor 140 is configured to determine that the one of oil palm trees P11, P14, and P23 is healthy. If one of oil palm trees P11, P14, and P23 does not have a match rate with any of the plurality of OSAVI template images to at least the fourth predetermined degree (e.g., less than the fourth OSAVI match threshold), processor 140 is configured to determine that plant disease exists in the one of oil palm trees P11, P14, and P23. That is, processor 140 is configured to determine that the one of oil palm trees P11, P14, and P23 is not healthy. The third and fourth predetermined degrees above may be the same or different. The third and fourth OSAVI match thresholds may be equal, or either one of them may be higher than the other.

The first and third OSAVI match thresholds respectively applied to subareas Z1 and Z2 may be equal, or either of them may be higher than the other. The second and fourth OSAVI match thresholds respectively applied to subareas Z1 and Z2 may be equal, or either of them may be higher than the other.

Additionally or alternatively, processor 140 of apparatus 100 may be configured to determine whether plant disease exists in oil palm trees in subarea Z2 by comparing RGB aerial images of the oil palm trees in subarea Z2 with one or more RGB template images of healthy oil palm trees. For example, processor 140 is configured to crop RGB aerial images of oil palm trees P11, P14, and P23 from image (b) in FIG. 6. Processor 140 is configured to obtain an RGB aerial image of a healthy oil palm tree from memory 160 as an RGB template image. Processor 140 is also configured to calculate match rates between RGB aerial images of oil palm trees P11, P14, and P23 and the RGB template image. If each of oil palm trees P11, P14, and P23 has a match rate to at least a third predetermined degree (e.g., greater than or equal to a third RGB match threshold), processor 140 is configured to determine that plant disease does not exist in oil palm trees P11, P14, and P23. That is, processor 140 is configured to determine that oil palm trees P11, P14, and P23 are healthy. If one of oil palm trees P11, P14, and P23 does not have a match rate to at least the third predetermined degree (e.g., less than the third RGB match threshold), processor 140 is configured to determine that plant disease exists in the one of oil palm trees P11, P14, and P23. That is, processor 140 is configured to determine that the one of oil palm trees P11, P14, and P23 is not healthy.

As another example, processor 140 is configured to obtain a plurality of RGB aerial images of healthy oil palm trees from memory 160 as a plurality of RGB template images. Processor 140 is further configured to calculate match rates between the RGB images of oil palm trees P11, P14, and P23 and the plurality of RGB template images. If one of oil palm trees P11, P14, and P23 has a match rate with any of the plurality of RGB template images to at least a fourth predetermined degree (e.g., greater than or equal to a fourth RGB match threshold), processor 140 is configured to determine that plant disease does not exist in the one of oil palm trees P11, P14, and P23. That is, processor 140 is configured to determine that the one of oil palm trees P11, P14, and P23 is healthy. If one of oil palm trees P11, P14, and P23 does not have a match rate with any of the plurality of RGB template images to at least the fourth predetermined degree (e.g., less than the fourth RGB match threshold), processor 140 is configured to determine that plant disease exists in the one of oil palm trees P11, P14, and P23. That is, processor 140 is configured to determine that the one of oil palm trees P11, P14, and P23 is not healthy. The third and fourth predetermined degrees above may be the same or different. The third and fourth RGB match thresholds may be equal, or either of them may be higher than the other.

The first and third RGB match thresholds respectively applied to subareas Z1 and Z2 may be equal, or either of them may be higher than the other. The second and fourth RGB match thresholds respectively applied to subareas Z1 and Z2 may be equal, or either one of them may be higher than the other.

Yet additionally or alternatively, processor 140 of apparatus 100 is configured to obtain side-view images of oil palm trees in subarea Z2 and corresponding GPS positions from the UGV via image interface 112. Processor 140 is configured to determine whether plant disease exists in an oil palm tree in subarea Z2 based on the side-view image of the oil palm tree, according to the determination by side-view images in subarea Z1 described above with reference to FIG. 6. For example, processor 140 is configured to calculate a match rate between the side-view image of oil palm tree P11 and a side-view template image including a fruiting body of Ganoderma. The match rate may be, e.g., 80% because the side-view image (e) of oil palm tree P11 in FIG. 6 includes several fruiting bodies of Ganoderma. Processor 140 is configured to determine that oil palm tree P11 has one or more fruiting bodies of Ganoderma because the match rate (80%) is higher than a side-view syndrome threshold, e.g., 75%. As a result, processor 140 is configured to determine that plant disease exists in oil palm tree 11. That is, processor 140 is configured to determine that oil palm tree P11 is not healthy.

In some embodiments, processor 140 is configured to determine that plant disease exists in one or more of the oil palm trees in the area based on OSAVIs, OSAVI images, and/or RGB aerial images of the oil palm trees. Nonetheless, plant disease may not actually exist in the one or more oil palm trees. Thus, processor 140 is further configured to determine whether plant disease exists in the one more oil palm trees based on side-view images of the one or more oil palm trees. For example, processor 140 may be configured to determine plant disease exists in oil palm trees P14, P23, and P26 based on the OSAVIs (as described above with reference to method 200 for detecting plant disease), the OSAVI images, RGB aerial images of the oil palm trees, as described above with reference to FIG. 2, images (a) and (b) in FIG. 5, and images (a) and (b) in FIG. 6. Processor 140 is further configured to determine whether plant disease exists in the one or more oil palm trees based on their side-view images, as described above with reference to images (c), (d), and (e) in FIG. 5 and images (c), (d), and (e) in FIG. 6 below.

As described above, Ganoderma disease in an oil palm tree may cause several visual symptoms that are observable from side-view images, such as unopened young leaves, necrosis in older leaves, a skirt-like crown with lower leaves, a white mycelium of Ganoderma, or a fruiting body of Ganoderma in different stages of the disease. Ganoderma disease may cause a number of fully elongated but unopened spears at a center of a crown of the oil palm tree. Ganoderma disease may also cause necrosis in older leaves of the oil palm tree. In addition, Ganoderma disease may cause a skirt-like crown of lower leaves of the oil palm tree because those leaves collapse and hang vertically down. Moreover, Ganoderma disease may gradually cause the white mycelium and fruiting bodies of Ganoderma to appear at a trunk of the oil palm tree in different stages of Ganoderma. In a life cycle of Ganoderma, a plurality of spores germinate and create a network of white mycelium. The mycelium of Ganoderma appears like spider webs. Fruiting bodies of Ganoderma may later begin to form from the mycelium. At a later stage, Ganoderma disease may also cause a base of the trunk to blacken, and the trunk of the oil palm tree may rot.

For example, the side-view image (d) of oil palm tree P26 in FIG. 5 shows that there is no syndrome in oil palm tree P26. Side-view images (e) and (c) in FIG. 6 show that oil palm trees P11 and P23 have a fruiting body of Ganoderma and a rotting trunk, respectively. In some embodiments, processor 140 is further configured to determine whether plant disease exists in oil palm trees P11, P23, and P26 by comparing the side-view images of oil palm trees P11, P23, and P26 with a plurality of side-view template images of non-healthy oil palm trees, including unopened young leaves, necrosis in older leaves, a skirt-like crown with lower leaves, a white mycelium of Ganoderma, a fruiting body of Ganoderma, and/or a rotting trunk.

For example, because the side-view image of oil palm tree P26 shown in image (d) in FIG. 5 does not include any of the above visual symptoms of Ganoderma, processor 140 is configured to determine that plant disease does not exist in oil palm tree P26 based on the side-view image of oil palm tree 26 and side-view template images of non-healthy oil palm trees. In this manner, although processor 140 is configured to determine that plant disease exists in oil palm tree P26 based on the OSAVI and the OSAVI disease threshold (0.92), processor 140 may be further configured to determine plant disease does not exist in oil palm tree P26 based on the side-view images. This result is correct because oil palm tree P26 has no plant disease, as shown in image (d) in FIG. 5.

As another example, because the side-view images (e) and (d) of oil palm trees P11 and P14 shown in FIG. 6 respectively include a fruiting body of Ganoderma and a rotting area on the trunk, processor 140 may be further configured to determine that plant disease exists in oil palm trees P11 and P14 based on comparing their side-view images with the plurality of side-view template images including the syndromes. The results are correct because oil palm trees P11 and P14 have plant disease, as shown in images (e) and (d) in FIG. 6.

In some embodiments, processor 140 is configured to obtain side-view images of the skirt-like crown of leaves (not shown) and unopened young leaves (not shown) and the side-view images of the blackened trunk, rotting trunk, and fruiting body of Ganoderma in images (c), (d), and (e) in FIG. 6 as side-view template images including disease symptoms for detecting plant disease in oil palm trees, as described in the present disclosure.

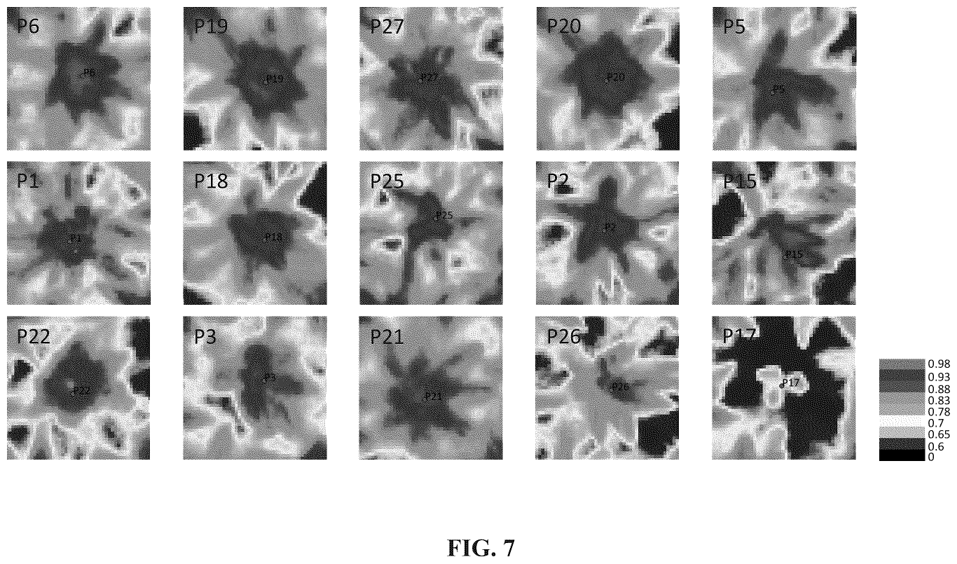

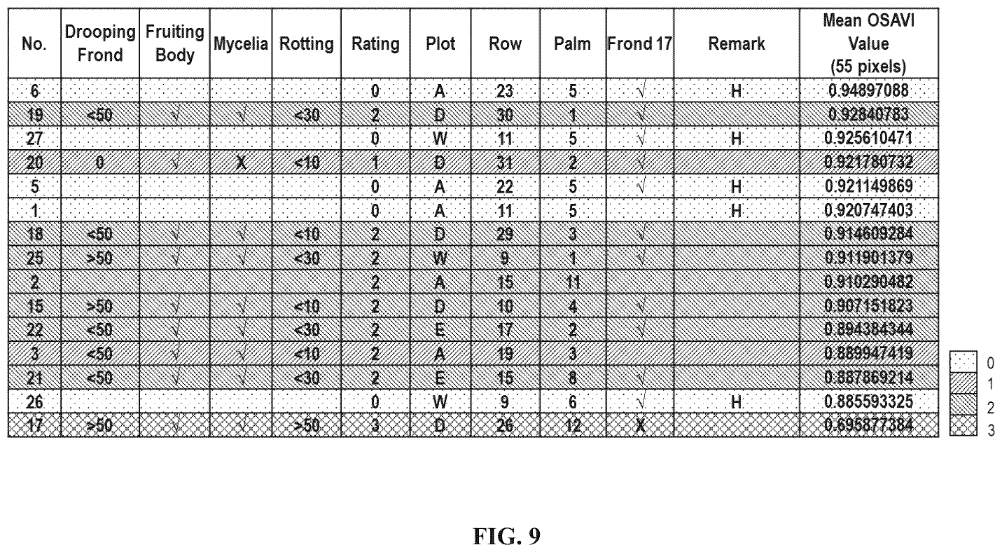

FIG. 7 illustrates color representations of OSAVI images of exemplary oil palm trees in subarea Z1 for detecting plant disease, according to some embodiments of the present disclosure. Processor 140 of apparatus 100 is configured to obtain OSAVI images of oil palm trees, such as the oil palm trees in subarea Z1 from the OSAVI image of the area in FIG. 4. The OSAVI images of the oil palm trees in FIG. 7 each include 200 pixels. Processor 140 is configured to calculate mean OSAVI values of the central fifty-five image pixels of the OSAVI images of the oil palm trees, as illustrated and described below with reference to FIG. 9.

As shown in FIG. 7, processor 140 is further configured to arrange the OSAVI images of exemplary oil palm trees P6, P19, P27, P20, P5, P1, P18, P25, P2, P15, P22, P3, P21, P26, and P17 in sequence based on mean OSAVI values of the oil palm trees. For example, the mean OSAVI values of the central fifty-five image pixels of oil palm trees P6, P19, P27, P20, and P5 are 0.948, 0.928, 0.925, 0.921, and 0.921 (FIG. 9), respectively. Accordingly, processor 140 is configured to arrange the OSAVI images of the five oil palm trees in a sequence of decreasing mean OSAVI values beginning with the image of oil palm tree P6 having the highest mean OSAVI value.

As shown in FIG. 7, the OSAVI images of oil palm trees P6, P19, P27, P20, and P5 appear to be complete top views of oil palm trees, similar to top views of healthy oil palm trees in RGB aerial images. However, the OSAVI image of oil palm tree P17 appears to be an incomplete top view of an oil palm tree. The mean OSAVI value of the central fifty-five pixels of oil palm tree P17 is 0.695 (FIG. 9). The completeness of OSAVI images of oil palm trees is positively correlated to the mean OSAVI values of the oil palm trees. Thus, processor 140 may be configured to determine whether plant disease exists in the oil palm trees based on the OSAVI images of the oil palm trees and one or more OSAVI template images. The OSAVI template images are a plurality of OSAVI images of healthy oil palm trees that are selected as templates for detecting healthy oil palm trees using a template matching method based on equation (1) below. Processor 140 is configured to calculate a match rate (R) between an OSAVI image (I′) of one of the plurality of oil palm trees and an OSAVI template imagine (T′) according to equation (1):

$$R ( x , y ) = \frac{{\sum }_{{x}^{′} {y}^{′}} ( {T}^{′} ( {x}^{′} , {y}^{′} ) \cdot {I}^{′} ( x + {x}^{′} , y + {y}^{′} ) )}{\sqrt{{\sum }_{{x}^{′} {y}^{′}} {{T}^{′} ( {x}^{′} , {y}^{′} )}^{2} \cdot {\sum }_{{x}^{′} {y}^{′}} {{I}^{′} ( x + {x}^{′} , y + {y}^{′} )}^{2}}} \qquad ( 1 )$$

where x and y define a reference pixel position on the OSAVI image (I′) of one of the plurality of oil palm trees, and x′ and y′ refer to pixel positions on the OSAVI template image (T′) and represent offset pixels from the reference pixel position (x, y) on the OSAVI image (I′).

If there are a plurality of OSAVI template images of healthy oil palm trees, processor 140 is configured to calculate a plurality of match rates (Rs) between the OSAVI image (I′) of the one of the plurality of oil palm trees and each of the plurality of OSAVI template images (T′) based on equation (1). Processor 140 is further configured to determine that plant disease does not exist in the one of the plurality of oil palm trees when one or more of the plurality of match rates (Rs) are higher than or equal to an OSAVI match threshold, such as 80%, 70%, or 60% of a self-match rate of the OSAVI template image (T′).

Alternatively or additionally, processor 140 may be configured to calculate match rates in plant disease detection methods herein according to a squared difference method, a normalized squared difference method, a cross-correlation method, a normalized cross-correlation method, a correlation coefficient method, a normalized correlation coefficient method, or any combination thereof.

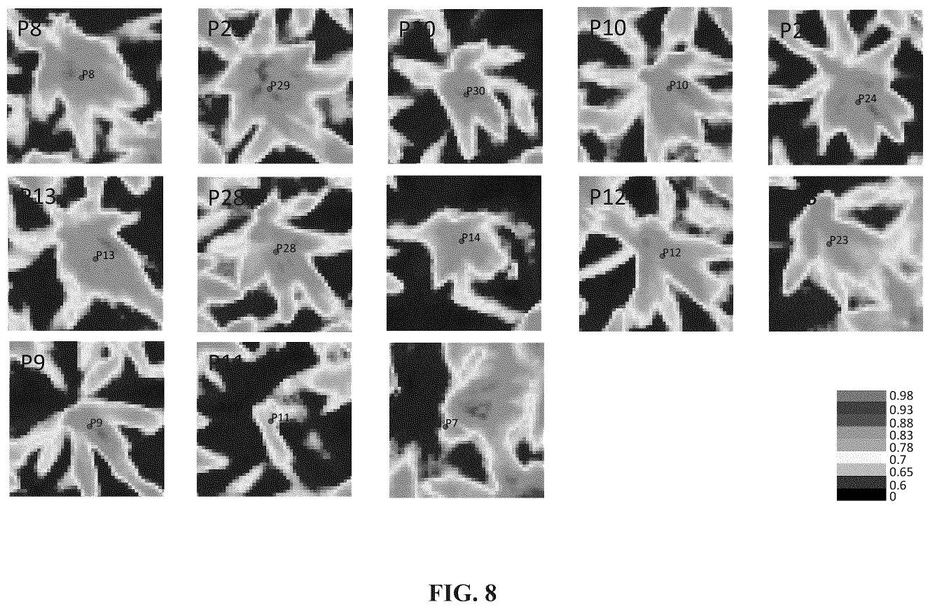

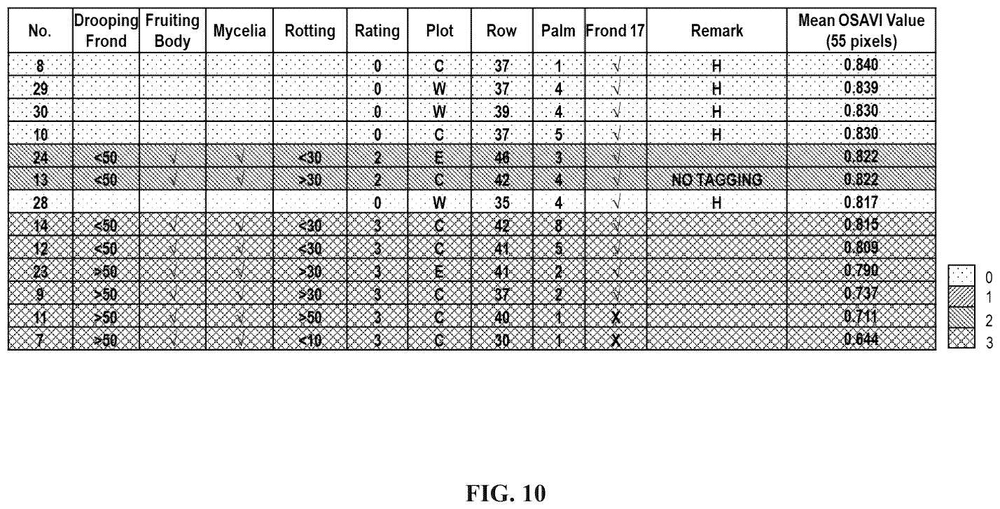

FIG. 8 illustrates color representations of OSAVI images of exemplary oil palm trees in subarea Z2 for detecting plant disease, according to some embodiments of the present disclosure. Processor 140 of apparatus 100 is configured to obtain OSAVI images of the oil palm trees in subarea Z2 from the OSAVI image of the area in FIG. 4. The OSAVI images of the oil palm trees in FIG. 8 each include 200 pixels. Processor 140 is configured to calculate mean OSAVI values of the central fifty-five pixels of the OSAVI images of the oil palm trees, as illustrated and described below with reference to FIG. 10.

As shown in FIG. 8, processor 140 is further configured to arrange the OSAVI images of oil palm trees P8, P29, P30, P10, P24, P13, P28, P14, P12, P23, P9, P11, and P7 in a sequence based on their respective OSAVI values. For example, the mean OSAVI values of the central fifty-five image pixels of the five oil palm trees P8, P29, P30, P10, and P24 are 0.84, 0.839, 0.83, 0.83, and 0.822 (FIG. 10), respectively. Accordingly, processor 140 is configured to arrange the images of the five oil palm trees in a sequence of decreasing OSAVI values beginning with the image of oil palm tree P8 having the highest OSAVI value.

As shown in FIG. 8, the OSAVI images of oil palm trees P8 and P29 appear to be complete top views of oil palm trees, similar to top views of healthy oil palm trees in RGB aerial images. However, it may be difficult to determine whether the OSAVI images of oil palm trees P30, P10, and P24 are top views of healthy oil palm trees. As another example, the OSAVI image of oil palm tree P11 appears to be an incomplete top view of an oil palm tree. The mean OSAVI value of the central fifty-five image pixels of oil palm tree P11 is 0.711 (FIG. 10). The completeness of OSAVI images of oil palm trees is positively correlated to the mean OSAVI values of the oil palm trees. The incomplete top view of an oil palm tree may be the appearance of an unhealthy oil palm tree. Thus, processor 140 may be configured to determine whether plant disease exists in each of the oil palm trees respectively based on the OSAVI images of the oil palm trees and one or more OSAVI template images of healthy oil palm trees, as described above by the template matching method.

In some embodiments, processor 140 of apparatus 100 is configured to detect healthy oil palm trees in subareas Z1 and Z2 by matching one or more OSAVI template images with OSAVI images of subarea Z1 and Z2 using equation (1). For example, processor 140 can be configured to match one or more OSAVI template images with OSAVI images in FIG. 4, image (a) in FIG. 5, and/or image (a) in FIG. 6.

FIG. 9 illustrates an exemplary table summarizing appearances of the exemplary oil palm trees in subarea Z1 shown in FIG. 7, according to some embodiments of the present disclosure. As shown in FIG. 9, the table includes information about “Drooping Frond,” “Fruiting Body,” “Mycelia,” “Rotting,” “Rating,” “Plot,” “Row,” “Palm,” “Frond 17,” “Remark,” and “Mean OSAV Value (of 55 pixels)” of oil palm trees. Blank entries in the table represent that related information is not available.

The “Drooping Frond” column includes information about whether more than 50% of fronds of an oil palm tree are drooping fronds. The “Fruiting Body” column includes information about whether an oil palm tree has any fruiting body, where a “√” symbol represents that the oil palm tree has at least one fruiting body. The “Mycelia” column includes information about whether an oil palm tree has mycelia on it, where a “√” symbol represents that the oil palm tree has mycelia, and an “X” symbol represents that the oil palm tree has no mycelia. The “Rotting” column includes information about whether the trunk of an oil palm tree has any rotting part, where “<30” and “<10” respectively represent that less than 30% and 10% of the trunk appears rotting, and “>50” represents that more than 50% of the trunk appears rotting. In some embodiments, processor 140 of apparatus 100 is configured to detect whether drooping frond, fruiting body, mycelia, and/or rotting appear on the plurality of oil palm trees by calculating match rates between side-view images (e.g., side-view photographs taken by UGV) of the plurality of oil palm trees with a plurality of side-view template images including drooping frond, fruiting body, mycelia, and/or rotting. Processor 140 is configured to determine that one or more of the appearances exist on an oil palm tree when one or more match rates are greater than or equal to a side-view match threshold, e.g., 75%. Processor 140 is also configured to determine that one or more of the appearances does not exist on an oil palm tree when the match rates are greater than or equal to the match threshold (e.g., 75%). Processor 140 is further configured to store whether a drooping frond, a fruiting body, mycelia, and/or rotting appear on the plurality of oil palm trees in memory 160, such as the contents shown in FIG. 9.

The “Rating” column includes a health rating from 0 to 3 for an oil palm tree, where a health rating of 0 is the healthiest, and a health rating of 3 is the most non-healthy. The health rating is determined by an experienced farmworker to verify the accuracy of determinations made by process 140. Processor 140 is configured to receive the health ratings of the plurality of oil palm trees via user interface 114 (FIG. 1). In addition to numerical information, processor 140 renders entries in the table in FIG. 9 by a set of drawing patterns, e.g., shading, stippling, and cross-hatching, corresponding to the health rating of 0 to 3. In this manner, FIG. 9 also represents a distribution of rated oil palm trees among the sequence of the oil palm trees based on the mean OSAVI values. For example, oil palm trees P6, P27, P5, and P1 with the health rating of 0 are ranked consistently as healthy oil palm trees in terms of the mean OSAVI values. Nonetheless, oil palm tree P26 with the health rating of 0 is ranked as less healthy because of its mean OSAVI value (0.885). This indicates an alternative means is required to identify oil palm tree P26 as healthy.

For example, when processor 140 is configured to determine the mean OSAVI value (0.0885) of oil palm tree P26 is less than an OSAVI threshold (e.g., 0.92), processor 140 is further configured to determine whether plant disease exists in oil palm tree P26 based on multispectral aerial images, side-view images, and/or values of chlorophyll b.

The “Plot,” “Row,” and “Palm” columns of the table in FIG. 9 include information about a location of an oil palm tree in the area. The information is recorded by a farmworker. Processor 140 is configured to receive the information via user interface 114 (FIG. 1).

The “Frond 17” column includes information about whether an oil palm tree has seventeen or more fronds. This information is checked by farmworkers and input to apparatus 100 through user interface 114 (FIG. 1). The seventeenth frond is used as an indicator for growth and nutrient conditions of an oil palm tree. In some embodiments, processor 140 of apparatus 100 is configured to detect whether the seventeenth frond appears on the plurality of oil palm trees by calculating match rates between side-view images (e.g., side-view photographs taken by UGV) of the plurality of oil palm trees with one or more side-view template images including the seventeenth frond. Processor 140 is configured to determine the seventeenth frond exists on an oil palm tree when one or more match rates are greater than or equal to a side-view match threshold, e.g., 70%. Processor 140 is also configured to determine the seventeenth frond does not exist on an oil palm tree when none of the one or more match rates are greater than or equal to the match threshold (70%). Processor 140 is further configured to store whether the seventeenth frond appears on the plurality of oil palm trees in memory 160, such as the contents shown in FIG. 9, where a “V” symbol represents that the oil palm tree has the seventeenth frond, and an “X” symbol represents that the oil palm tree does not have the seventeenth frond.

The “Remark” column includes information about whether an “H” mark is on an oil palm tree. The “H” mark represents that the oil palm tree is checked by a farmworker and recognized as a healthy oil palm tree. Processor 140 is configured to receive the information via user interface 114 (FIG. 1). Processor 140 is further configured to store the information in memory 160, such as the contents shown in FIG. 9.

The “Mean OSAVI Value” column includes the mean value of OSAVI of the central fifty-five pixels in the OSAVI image of an oil palm tree, i.e., the OSAVI images in FIG. 7. Processor 140 of apparatus 100 is configured to calculate mean values of OSAVI of the central fifty-five pixels in OSAVI images of the plurality of oil palm trees. Processor 140 is further configured to store the mean values of OSAVI of the plurality of oil palm trees in memory 160, such as the contents shown in FIG. 9.

When the OSAVI disease threshold in step 240 is set as, for example, 0.92 for oil palm trees in subarea Z1, processor 140 of apparatus 100 is configured to determine that plant disease does not exist in oil palm trees P6, P19, P27, P20, P5, and P1 based on that OSAVI disease threshold. Processor 140 is configured to determine that plant disease exists in oil palm trees P18, P25, P2, P15, P22, P3, P21, P26, and P17 based on the same OSAVI disease threshold. In some embodiments, after processor 140 determines that plant disease exists in oil palm trees P18, P25, P2, P15, P22, P3, P21, P26, and P17, processor 140 is configured to generate an indication of the plant disease. Alternatively, in some other embodiments, after processor 140 determines that plant disease exists in oil palm trees P18, P25, P2, P15, P22, P3, P21, P26, and P17, processor 140 is further configured to determine whether plant disease exists in these oil palm trees based on multispectral aerial images, side-view images, and/or values of chlorophyll b, as described in the present disclosure. For example, processor 140 may be further configured to determine that plant disease does not exist in oil palm tree P26 based on one or more match rates between an OSAVI image of oil palm tree P26 and one or more OSAVI template images of one or more healthy oil palm tree.

FIG. 10 illustrates an exemplary table summarizing appearances of the exemplary oil palm trees in subarea Z2 shown in FIG. 8, according to some embodiments of the present disclosure. As shown in FIG. 10, the table also includes information about “Drooping Frond,” “Fruiting Body,” “Mycelia,” “Rotting,” “Rating,” “Plot,” “Row,” “Palm,” “Frond 17,” “Remark,” and “Mean OSAVI Value” of oil palm trees, presented in a similar manner as described above with reference to FIG. 9. The information is also recorded in memory 160 by one or more farmworkers and by processor 140 of apparatus 100, as described above with reference to FIG. 9.

When the OSAVI disease threshold in step 240 is set as, for example, 0.825 for oil palm trees in subarea Z2, processor 140 of apparatus 100 is configured to determine that plant disease does not exist in oil palm trees P8, P29, P30, and P10. Processor 140 is also configured to determine that plant disease may exist in oil palm trees P24, P13, P28, P14, P12, P23, P9, P11, and P7. In some embodiments, after processor 140 determines that plant disease exists in oil palm trees P24, P13, P28, P14, P12, P23, P9, P11, and P7, processor 140 is configured to generate an indication of the plant disease. However, oil palm tree P28 is healthy in view of its rating of 0 (FIG. 10). In some other embodiments, after processor 140 determines that plant disease may exist in oil palm trees P24, P13, P28, P14, P12, P23, P9, P11, and P7, processor 140 is further configured to determine whether plant disease exists in these oil palm trees based on multispectral aerial images, side-view images, and/or values of chlorophyll b, as described in the present disclosure. For example, processor 140 may be further configured to determine plant disease does not exist in oil palm tree P28 based on one or more side-view images of oil palm tree P28, based on template matching between one or more OSAVI images of oil palm tree P28 and one or more OSAVI template images of one or more healthy oil palm trees, and/or based on a value of chlorophyll b of oil palm tree P28 and a threshold value of chlorophyll b.

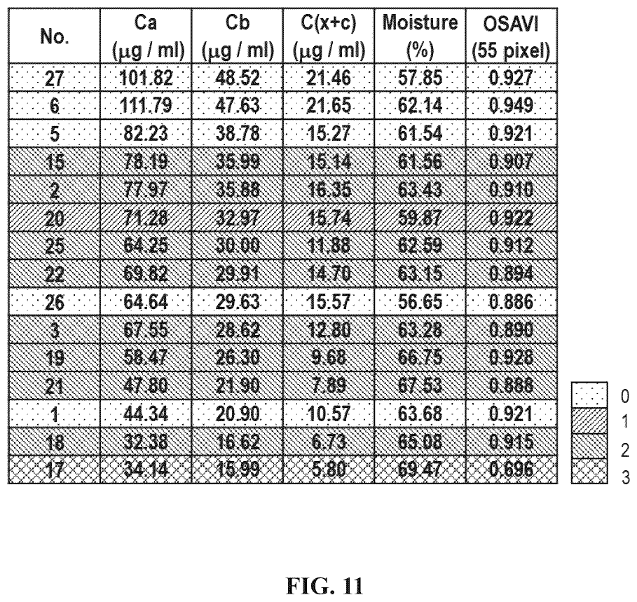

FIG. 11 illustrates an exemplary table of leaf chlorophyll content and moisture of the exemplary oil palm trees in subarea Z1 shown in FIG. 7, according to some embodiments of the present disclosure. The information is obtained from an analysis of leaves of oil palm trees by, for example, MINOLTA SPAD-502 and Agilent Chlorophyll and Carotenoid measurement machines. Processor 140 of apparatus 100 is configured to obtain the information via user interface 114 (FIG. 1) and store it in memory 160 (FIG. 1). As shown in FIG. 11, the table includes information about chlorophyll a (“Ca”), chlorophyll b (“Cb”), and chlorophyll x+c (“C(x+c)”) contents, as well as moisture and mean OSAVI values of oil palm trees. The trees in the first column of the table are listed in descending order of chlorophyll b content. Processor 140 renders the entries of the table in FIG. 11 by the same set of drawing patterns corresponding to the health rating of 0 to 3, as for the table in FIG. 9. In this manner, FIG. 11 also presents a distribution of rated oil palm trees among the sequence of the oil palm trees based on the chlorophyll b content.

As shown in FIG. 11, the leaf chlorophyll content is positively correlated to the health rating. Chlorophyll b content provides a better correlation with the visual rating than other chlorophyll contents. Moisture of an oil palm tree appears to be irrelevant to the rating. In some embodiments, processor 140 is configured to determine whether plant disease exists in an oil palm tree based on the leaf chlorophyll content of the oil palm tree, as explained below.

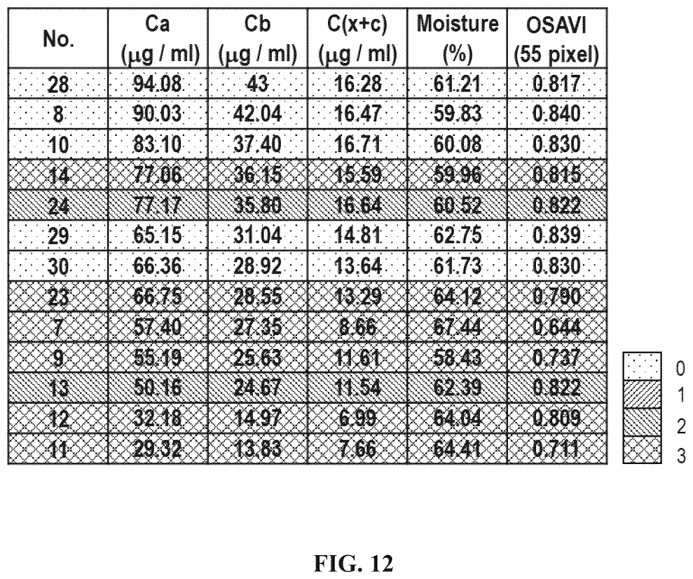

FIG. 12 illustrates an exemplary table of leaf chlorophyll content and moisture of the exemplary oil palm trees in subarea Z2 shown in FIG. 8, according to some embodiments of the present disclosure. The information is obtained from the analysis of leaves of oil palm trees by, for example, MINOLTA SPAD-502 and Agilent Chlorophyll and Carotenoid measurement machines. Processor 140 of apparatus 100 is configured to obtain the information via user interface 114 (FIG. 1) and store the information in memory 160 (FIG. 1). As shown in FIG. 12, the table includes information about chlorophyll a (“Ca”), chlorophyll b (“Cb”), and chlorophyll x+c (“C(x+c)”) contents, as well as moisture and mean OSAVI values of oil palm trees. Processor 140 renders the entries in the table in FIG. 12 by the same set of drawing patterns corresponding to the health rating of 0 to 3, as for the table in FIG. 10. In this manner, FIG. 12 also presents a distribution of rated oil palm trees among the sequence of the oil palm trees based on the chlorophyll b content. The table entries are listed in descending order of chlorophyll b content. As shown in FIG. 12, the leaf chlorophyll content is roughly positively correlated to the health rating.

In some embodiments, processor 140 of apparatus 100 is configured to determine whether plant disease exists in an oil palm tree based on the leaf chlorophyll content of the oil palm tree. For example, processor 140 is configured to obtain Cb values of a plurality of oil palm trees listed in FIG. 11 (subarea Z1) via user interface 114 (FIG. 1). The Cb values of the plurality of oil palm trees may be measured by the above-noted measurement machines. Processor 140 is configured to determine whether plant disease exists in the plurality of oil palm trees based on a Cb threshold, e.g., 30 μg/ml. Specifically, processor 140 is configured to compare the Cb values of the plurality of oil palm trees listed in FIG. 11 with the Cb threshold (30 μg/ml) and determine that plant disease does not exist in oil palm trees P27, P6, P5, P15, P2, P20, and P25 because these oil palm trees have Cb values higher than or equal to the Cb threshold (30 μg/ml). Processor 140 is also configured to determine that plant disease exists in oil palm trees P22, P26, P3, P19, P21, P1, P18, and P17 because these oil palm trees have Cb values lower than the Cb threshold (30 μg/ml).

As another example, processor 140 is configured to compare Cb values of the plurality of oil palm trees listed in FIG. 12 (subarea Z2) with the Cb threshold (30 μg/ml) and determine that plant disease does not exist in oil palm trees P28, P8, P10, P14, P24, and P29 because these oil palm trees have Cb values higher than or equal to the Cb threshold (30 μg/ml). Processor 140 is also configured to determine that plant disease exists in oil palm trees P30, P23, P7, P9, P13, P12, and P11 because these oil palm trees have Cb values lower than the Cb threshold (30 μg/ml).

In some embodiments, processor 140 of apparatus 100 is configured to determine whether plant disease exists in an oil palm tree based on both the Cb threshold and the OSAVI threshold. For example, processor 140 is configured to determine plant disease does not exist in oil palm trees P27, P6, and P5 because these oil palm trees' Cb values (FIG. 11) and OSAVI values (FIG. 11) are both higher than the Cb threshold (30 μg/ml) and the OSAVI threshold (0.92), respectively. Processor 140 is configured to determine plant disease exists in oil palm tree P19 because oil palm tree P19's Cb value (26.3 in FIG. 11) is lower than the Cb threshold (30 μg/ml), although oil palm tree P19's OSAVI value (0.928 in FIG. 11) is higher than the OSAVI threshold 0.92.

Alternatively, in some embodiments, processor 140 of apparatus 100 is configured to determine whether plant disease exists in an oil palm tree when one of the Cb threshold and the OSAVI threshold is passed. For example, processor 140 is configured to determine plant disease does not exist in oil palm tree P15 because oil palm tree P15's Cb value (35.99) is higher than the Cb threshold (30 μg/ml), although oil palm tree P15's OSAVI value (0.907 in FIG. 17) is lower than the OSAVI threshold (0.92). Processor 140 is configured to determine plant disease exists in oil palm tree P26 because oil palm tree P26's Cb value is lower than the threshold 30 μg/ml and oil palm tree P19's OSAVI value (0.886 in FIG. 11) is lower than the OSAVI threshold (0.92).

In some embodiments, the disease threshold in step 240 (FIG. 2), i.e., a selected OSAVI value, is associated with at least one of a ratio of a green color to a non-green color (“green-to-non-green ratio” hereinafter) in the plurality of plants, a color of soil in the area, or one or more properties of soil in the area. The green-to-non-green ratios are determined by processor 140 as described more fully below. For example, oil palm trees in subarea Z1 are healthier than those in subarea Z2 because soil of subarea Z1 is more fertile than subarea Z2. The oil palm trees in subarea Z1 appears to contain a higher green-to-non-green ratio than subarea Z2. When Ganoderma disease exists in an oil palm tree in subarea Z1, the oil palm tree might still appear to contain a higher green-to-non-green ratio than an oil palm tree with, or even without, Ganoderma disease in subarea Z2. In this way, the disease threshold, i.e., an OSAVI value, for oil palm trees in subarea Z1 needs to be set higher than that for subarea Z2 in order to be able to detect plant disease with accurate results.

For example, processor 140 of apparatus 100 is configured to select the disease threshold used in step 240, i.e., an OSAVI value, based on the green-to-non-green ratio in the plurality of plants of subarea Z1. Memory 160 stores a mapping table that correlates green-to-non-green ratios to a plurality of OSAVI values. First and second entries of the mapping table correlate first and second green-to-non-green ratios to first and second OSAVI values, respectively. If the first green-to-non-green ratio is greater than the second green-to-non-green ratio, the first OSAVI value is higher than the second OSAVI value. That is, the disease threshold in the first entry of the mapping table is higher than that in the second entry of the table. Processor 140 is configured to select an entry of the mapping table based on a green-to-non-green ratio of a plurality of plants in an area to determine the disease threshold used in step 240. For example, the OSAVI or RGB image of subarea Z1 includes a plurality of pixels. Each pixel contains a green color value and non-green color values. Processor 140 is configured to divide an average green color value by an average non-green color value of the OSAVI or RGB image of subarea Z1 to obtain the green-to-non-green ratio for subarea Z1. Processor 140 is further configured to select, for example, an OSAVI value of 0.92 based on the green-to-non-green ratio for subarea Z1 according to the mapping table in memory 160.

When apparatus 100 detects plant disease in subarea Z2, processor 140 is configured to divide an average green color value by an average non-green color value of the OSAVI or RGB image of subarea Z2 to obtain a green-to-non-green ratio for subarea Z2. Processor 140 is further configured to select, for example, an OSAVI value of 0.825 based on the green-to-non-green ratio for subarea Z2 according to the mapping table in memory 160. Since the green-to-non-green ratio for subarea Z1 is higher than the green-to-non-green ratio for subarea Z2, the selected OSAVI value (0.92) for subarea Z1 is higher than the selected value (0.825) for subarea Z2.

As noted above, in the present exemplary embodiment, a first OSAVI disease threshold applied to oil palm trees in subarea Z1 is set as 0.92, and a second OSAVI disease threshold applied to oil palm trees in subarea Z2 is set as 0.825. Thus, the first OSAVI disease threshold, applied to subarea Z1 with a higher green-to-non-green ratio in the oil palm trees therein, is higher than the second OSAVI disease threshold, applied to subarea Z2. In other words, the OSAVI disease threshold is associated with the green-to-non-green ratio of the plurality of plants in the area.

As described above, subarea Z1 is assumed to have more fertile soil than subarea Z2 such that the fertile soil of subarea Z1 has a darker color than the soil of subarea Z2. The fertile soil of subarea Z1 promotes healthier growth of oil palm trees than oil palm trees in subarea Z2. In some embodiments, processor 140 of apparatus 100 is configured to select the disease threshold used in step 240 of method 200, i.e., an OSAVI value, based on the soil darkness of subarea Z1. Memory 160 stores a mapping table that correlates soil darkness values to a plurality of OSAVI values. Processor 140 is configured to detect regions on the OSAVI or RGB image of subarea Z1 to be soil. Processor 140 is further configured to average the color values of the soil regions to obtain a soil darkness value of subarea Z1. Processor 140 is further configured to select, for example, an OSAVI value of 0.92 based on the soil darkness value of subarea Z1 according to the mapping table in memory 160.

When apparatus 100 is configured to detect plant disease in subarea Z2, processor 140 is configured to detect soil regions and calculate a soil darkness value of subarea Z2 accordingly. Processor 140 of apparatus 100 is further configured to select, for example, an OSAVI value of 0.825 based on the soil darkness value of subarea Z2 according to the mapping table in memory 160. Since the soil darkness value of subarea Z1 is higher than the soil darkness value of subarea Z2, the selected OSAVI value (0.92) for subarea Z1 is higher than the selected value (0.825) for subarea Z2.

As noted above, the first OSAVI disease threshold applied to subarea Z1, i.e., 0.92, is higher than the second OSAVI disease threshold applied to subarea Z2, i.e., 0.825. Thus, the first OSAVI disease threshold, applied to subarea Z1 with the darker color of soil, is higher than the second OSAVI disease threshold, applied to subarea Z2. Accordingly, the OSAVI disease threshold is associated with the color of soil in the area.

In the present embodiments, the soil of subarea Z1 is assumed to have more nutrimental soil properties, such as higher NPK fertility, slightly higher acidic pH value, higher Ca²⁺/Mg²⁺, softer soil texture, more microorganisms than subarea Z2. The nutrimental soil properties of subarea Z1 promote healthier growth of oil palm trees than oil palm trees in subarea Z2. Given the first OSAVI disease threshold applied to subarea Z1 is higher than the second OSAVI disease threshold applied to subarea Z2, the first OSAVI disease threshold applied to subarea Z1 with the nutrimental soil properties is higher than the second OSAVI disease threshold applied to subarea Z2. Accordingly, the OSAVI disease threshold is associated with the soil properties in the area.

In some embodiments, the vegetation indices in step 230 (FIG. 2) include at least one of: a plurality of normalized difference vegetation indices or a plurality of soil-adjusted vegetation indices. As used herein and more fully described below, vegetation index can refer to either of the OSAVI value or a normalized difference vegetation index (NDVI). For example, in some embodiments, in addition to or alternatively to calculating the OSAVI values, processor 140 of apparatus 100 is configured to calculate the normalized difference vegetation index (NDVI) corresponding to each pixel of the multispectral image of the area based on an NDVI formula and the image data of the multispectral image in red, green, blue, red edge, and near-infrared bands. The NDVI formula is

$$NDVI = \frac{NIR - Red}{NIR - Red} ,$$

where NIR is the reflectance in the near-infrared band, and Red is the reflectance in the red band, the reflections being included in the image data. Processor 140 may be configured to obtain the image data in red, green, blue, red edge, and near-infrared bands captured by the multispectral camera on UAV 110 via image interface 112 (FIG. 1), calculate NDVIs at a plurality of pixels of a multispectral image of the area by the NDVI formula above, and represent the NDVIs corresponding to the plurality of pixels of the multispectral image of the area by a set of colors to form an NDVI image of the area. The NDVI image of the area is not shown herein. The NDVI image of the area is also a multispectral aerial image of the area containing NDVIs and the image data in red, green, blue, red edge, and near-infrared bands.

Processor 140 is configured to determine whether plant disease exists in the plurality of oil palm trees respectively based on a plurality of NDVIs corresponding to the oil palm trees and an NDVI disease threshold. The NDVI disease threshold can be set as, for example, 0.93 or 0.845. Processor 140 is further configured to calculate an average NDVI value of a number of pixels for each oil palm tree. The number of pixels may be, e.g., 200 or 55 pixels on which the oil palm tree appears. If an average NDVI value of an oil palm tree is less than the NDVI disease threshold, processor 140 is configured to determine that plant disease exists in the oil palm tree. If the average NDVI value of the oil palm tree is equal to or greater than the NDVI disease threshold, processor 140 is configured to determine that plant disease does not exist in the oil palm tree.

Additionally or alternatively, processor 140 of apparatus 100 is configured to determine the plurality of OSAVIs respectively corresponding to the plurality of oil palm trees in step 220, and determine whether plant disease exists in the oil palm trees based on the OSAVIs and the OSAVI disease threshold, as described above with reference to FIG. 4.

In some embodiments, determining whether plant disease exists in the plurality of plants in step 240 (FIG. 2) includes determining that plant disease exists in one of the plurality of plants when none of OSAVI and NDVI corresponding to the one of the plurality of plants is less than the disease threshold; or determining that plant disease does not exist in the one of the plurality of plants when at least one of OSAVI or NDVI corresponding to the one of the plurality of plants is equal to or greater than the disease threshold.

For example, processor 140 of apparatus 100 is configured to determine that plant disease exists in oil palm tree P17 because the OSAVI of oil palm tree P17 (0.695 in FIG. 9) is less than the OSAVI disease threshold (0.92) and an NDVI (e.g., 0.66) of oil palm tree P17 is less than an NDVI disease threshold (0.85). As another example, processor 140 is configured to determine that the OSAVI of oil palm tree P6 (0.948 in FIG. 9) is greater than the OSAVI disease threshold (0.92). Processor 140 may or may not be further configured to compare an NDVI of oil palm tree P6 with an NDVI disease threshold. Because oil palm tree P6 has at least the OSAVI greater than the OSAVI disease threshold, processor 140 is configured to determine that plant disease does not exist in oil palm tree P6.

In some embodiments, determining whether plant disease exists in the plurality of plants in step 240 (FIG. 2) includes determining that plant disease exists in one of the plurality of plants when none or only one of OSAVI and NDVI, corresponding to the one of the plurality of plants, is less than the disease threshold; or determining that plant disease does not exist in the one of the plurality of plants when both of OSAVI and NDVI corresponding to the one of the plurality of plants are equal to or greater than the disease thresholds.

For example, processor 140 of apparatus 100 is configured to determine that plant disease exists in oil palm tree P17 because the OSAVI of oil palm tree P21 (0.887 in FIG. 9) is less than the OSAVI disease threshold (0.92) and an NDVI (e.g., 0.87) of oil palm tree P21 is greater than an NDVI disease threshold (0.85). That is, although oil palm tree P21 has the NDVI greater than the NDVI disease threshold, oil palm tree P21 has the OSAVI less than the OSAVI disease threshold. Processor 140 is therefore configured to determine that plant disease exists in oil palm tree P26. As another example, processor 140 is configured to determine that the OSAVI of oil palm tree P6 (0.948 in FIG. 9) is greater than the OSAVI disease threshold (0.92) and an NDVI (0.89) of oil palm tree P6 is greater than an NDVI disease threshold (e.g., 0.85). Because both the OSAVI and NDVI of oil palm tree P6 are greater than the OSAVI and NDVI disease thresholds, respectively, processor 140 is configured to determine that plant disease does not exist in oil palm tree P6.

In some embodiments, in response to a determination that plant disease exists in one of the plurality of plants (e.g., in step 240), processor 140 of apparatus 100 is further configured to determine whether the plant disease is Ganoderma disease based on a side-view image of the one of the plurality of plants. When the side-view image of the one of the plurality of plants includes at least one of a skirt-like crown of leaves, a mycelium, a fruiting body, a drooping frond, or a rotting trunk, processor 140 is configured to determine the plant disease is Ganoderma disease.

For example, after processor 140 determines that plant disease exists in oil palm tree P11, processor 140 is further configured to determine whether the plant disease is Ganoderma disease based on a side-view image of oil palm tree P11 and one or more side-view template images including visual symptoms of Ganoderma disease. Specifically, processor 140 is configured to obtain one or more side-view images of oil palm tree P11, such as the side-view image of oil palm tree P11 shown in image (e) in FIG. 6. Processor 140 is configured to calculate match rates between the one or more side-view images of oil palm tree P11 with the one or more side-view template images including visual symptoms of Ganoderma disease. As shown in image (e) in FIG. 6, the side-view image of oil palm tree P11 includes at least four fruiting bodies of Ganoderma. If the one or more side-view template images include fruiting bodies of Ganoderma, a match rate between the side-view image of oil palm tree P11 and the side-view template image would be a higher value than a side-view match threshold. Processor 140 is configured to determine the plant disease in oil palm tree P11 is Ganoderma disease.

In a similar manner, processor 140 may be configured to determine whether a side-view image of oil palm tree P11 includes one or more of a skirt-like crown of leaves, a mycelium of Ganoderma, a drooping frond, or a rotting trunk, by template matching. Additionally or alternatively, processor 140 may be configured to determine whether a side-view image of oil palm tree P11 includes a rotting trunk by comparing a color of the trunk of oil palm tree P11 in the side-view image with one or more color template images of rotting trunks. The color template images of rotting trunks include a plurality of color images of rotting trunks in various rotting states.

When oil palm tree P11 has one or more of the above visual symptoms of Ganoderma disease, processor 140 is configured to determine that plant disease in oil palm tree P11 is Ganoderma disease.

In some embodiments, determining the plurality of vegetation indices respectively corresponding to the plurality of plants based on the multispectral aerial image of the area in step 230 (FIG. 2) includes calculating one of the vegetation indices corresponding to one of the plurality of plants as an average vegetation index of a first number of pixels in the multispectral aerial image of the area. The one of the plurality of plants spans a second number of pixels in the multispectral aerial image of the area. The first number of pixels are included in the second number of pixels.

For example, the OSAVI image of oil palm tree P8 in FIG. 8 includes 200 pixels. If the OSAVI of oil palm tree P8 is an average of OSAVIs of all 200 pixels, the OSAVI of oil palm tree P8 is 0.75, which is less than the OSAVI disease threshold (0.825). Accordingly, processor 140 of apparatus 100 may be configured to determine that plant disease exists in oil palm tree P8. However, oil palm tree P8 is healthy. Thus, processor 140 is configured to calculate the OSAVI of oil palm tree P8 as an average of OSAVIs of only the central 55 pixels among the 200 pixels, which is 0.84, as shown in FIG. 10. Accordingly, processor 140 is configured to correctly determine that plant disease does not exist in oil palm tree P8.

For example, after processor 140 of apparatus 100 determines that Ganoderma disease exists in at least one of the oil palm trees in the area, processor 140 is configured to generate an indication of Ganoderma disease. The indication includes information that Ganoderma disease exists in one or more oil palm trees in the area and which one(s) of the oil palm trees has Ganoderma disease. For example, the indication includes information about Ganoderma disease in at least oil palm trees P18, P25, P2, P15, P22, P3, P21, P26, P17, P24, P13, P28, P14, P12, P23, P9, P11, and P7, as the OSAVI disease thresholds 0.92 and 0.825 are respectively applied to the oil palm trees in FIGS. 9 and 10.

Step 245 includes determining whether plant disease exists in one of the plurality of plants based on multispectral aerial images, side-view images, and/or values of chlorophyll b when the one of the plurality of plants has an acceptable vegetation index. Method 200 may further include optional step 245, as described in detail below.

In some embodiments of method 200 including step 245, the OSAVI disease threshold in step 240 is a first disease threshold. Step 245 includes identifying one of the plurality of plants with a vegetation index less than the first disease threshold and greater than a second disease threshold. The first disease threshold is greater than the second disease threshold. Step 245 also includes obtaining a plurality of multispectral aerial images of the plurality of plants. Step 245 further includes obtaining one or more multispectral aerial images of one or more healthy plants as one or more template images and determining whether plant disease exists in the one of the plurality of plants based on the plurality of multispectral aerial images of the plurality of plants and the one or more healthy plant template images. That is, in these embodiments, step 245 includes determining plant disease does not exist in a plant when the plant has an acceptable vegetation index and a multispectral aerial image matching the one or more healthy plant multispectral template images to a predetermined degree. If the one of the plurality of plants has a vegetation index less than the second disease threshold, step 245 further includes determining that plant disease exists in the one of the plurality of plants.

For example, the OSAVI disease threshold of 0.92 may be the first disease threshold for subarea Z1. A second OSAVI disease threshold for subarea Z1 may be 0.85. Processor 140 of apparatus 100 may be configured to determine that the OSAVI value of oil palm tree P26 is less than the first OSAVI disease threshold (0.92) and greater than the second OSAVI disease threshold (0.85). Processor 140 may be further configured to obtain the OSAVI image of oil palm tree P26 (FIG. 7) and an OSAVI image of a healthy plant, e.g., oil palm tree P5 (FIG. 7), as an OSAVI template image. Processor 140 may be further configured to calculate a match rate between the OSAVI images of oil palm trees P26 and P5 to be, for example, 85%. Processor 140 may be further configured to determine plant disease does not exist in oil palm tree P26 because the match rate (85%) between the OSAVI images of oil palm trees P26 and P5 is greater than an OSAVI match rate threshold, e.g., 80%. If processor 140 is configured to calculate the match rate between the OSAVI images of oil palm trees P26 and P5 to be 78%, which is less than the OSAVI match rate threshold (80%), processor 140 may be further configured to determine plant disease exists in oil palm tree P26.

In some embodiments of method 200 including step 245, the OSAVI disease threshold in step 240 is a first disease threshold. Step 245 includes identifying one of the plurality of plants with a vegetation index less than the first disease threshold and greater than a second disease threshold. The first disease threshold is greater than the second disease threshold. Step 245 also includes obtaining a side-view image of the one of the plurality of plants and determining whether plant disease exists in the one of the plurality of plants based on the side-view image and one or more side-view template images. That is, in these embodiments, step 245 includes determining plant disease does not exist in a plant when the plant has an acceptable vegetation index and a side-view image matching the one or more side-view template images to a predetermined degree. If the one of the plurality of plants has a vegetation index less than the second disease threshold, step 245 further includes determining that plant disease exists in the one of the plurality of plants.

For example, the OSAVI disease threshold of 0.92 is the first disease threshold and the second OSAVI disease threshold may be 0.85. Processor 140 of apparatus 100 is configured to determine that the OSAVI value of oil palm tree P26 is less than the first OSAVI disease threshold (0.92) and greater than the second OSAVI disease threshold (0.85). Processor 140 is further configured to obtain a side-view image of oil palm tree P26 and obtain one or more side-view template images of one or more healthy or non-healthy oil palm trees. Processor 140 is further configured to determine whether plant disease exists in oil palm tree P26 based on the side-view image of oil palm tree P26 and the one or more side-view template images.

When processor 140 is configured to obtain the one or more side-view template images from the one or more non-healthy oil palm trees, processor 140 may be configured to calculate one or more side-view match rates between the side-view image of oil palm tree P26 and the one or more side-view template images of non-healthy oil palm trees, including unopened young leaves, necrosis in older leaves, a skirt-like crown with lower leaves, a white mycelium of Ganoderma, a fruiting body of Ganoderma, and/or a rotting trunk. Because the side-view image of oil palm tree P26 (FIG. 5) does not include any of the above visual symptoms, the one or more side-view match rates of oil palm tree P26 may be one or more of, e.g., 30%, 20%, 35%, 28%, 33%, and 25%, all of which are lower than a side-view match rate threshold, e.g., 60%. Accordingly, processor 140 is configured to determine that plant disease does not exist in oil palm tree P26.

When processor 140 is configured to obtain the one or more side-view template images from the one or more healthy oil palm trees, processor 140 may be configured to calculate one or more side-view match rates between the side-view image of oil palm tree P26 and the one or more side-view template images of healthy oil palm trees. Because the side-view image of oil palm tree P26 does not include any of the above visual symptoms, the one or more side-view match rates of oil palm tree P26 may be one or more of, e.g., 80%, 85%, 75%, 88%, 83%, and 77%, at least one of which is greater than a side-view match rate threshold, e.g., 80%. Accordingly, processor 140 is configured to determine that plant disease does not exist in oil palm tree P26.

If one of the plurality of plants has an OSAVI value less than the second match threshold (0.85), processor 140 is configured to determine that plant disease exists in the one of the plurality of plants.

In some embodiments of method 200 including step 245, the disease threshold in step 240 is a first disease threshold. Step 245 includes identifying one of the plurality of plants with a vegetation index (e.g., an OSAVI value) less than the first disease threshold and greater than a second disease threshold. The first disease threshold is greater than the second disease threshold. Step 245 also includes obtaining a value of chlorophyll b content in a leaf of the one of the plurality of plants and determining whether plant disease exists in the one of the plurality of plants based on the value of chlorophyll b content and a third disease threshold. That is, in these embodiments, step 245 includes determining plant disease does not exist in a plant when the plant has an acceptable vegetation index and a value of chlorophyll b content greater than or equal to the third disease threshold. If the one of the plurality of plants has a vegetation index less than the second disease threshold, step 245 further includes determining that plant disease exists in the one of the plurality of plants.

For example, the OSAVI disease threshold of 0.92 is the first disease threshold and the second OSAVI disease threshold may be 0.85. Processor 140 of apparatus 100 is configured to determine that the OSAVI value of oil palm tree P26 is less than the first OSAVI disease threshold (0.92) and greater than the second OSAVI disease threshold (0.85). Processor 140 is further configured to obtain a value of chlorophyll b (Cb) content (29.63 μg/ml in FIG. 11) in a leaf of oil palm tree P26 and to determine whether plant disease exists in oil palm tree P26 based on the value of chlorophyll b content (29.63 μg/ml) and a Cb disease threshold of, e.g., 25 μg/ml. Processor 140 is configured to compare the value of Cb content of oil palm tree P26 (29.63 μg/ml) with the Cb disease threshold (25 μg/ml) and determine that plant disease does not exist in oil palm tree P26 because oil palm tree P26 has the value of Cb content (29.63 μg/ml) higher than the Cb disease threshold (25 μg/ml).

As another example, processor 140 may be configured to determine that plant disease exists in oil palm trees P21 because oil palm tree P21 has a Cb value of 21.9 μg/ml, which is lower than the Cb disease threshold (25 μg/ml).

If one of the plurality of plants has an OSAVI value less than the second match threshold (0.85), processor 140 is configured to determine that plant disease exists in the one of the plurality of plants.

In some of the above embodiments of step 245, determining whether plant disease exists based on a first one of the multispectral aerial image, side-view image, and value of chlorophyll b criteria, step 245 may further include determining whether plant disease exists based on a second one of the multispectral aerial image, side-view image, and value of chlorophyll b criteria when the first criterion is acceptable, i.e., less than a first threshold but greater or equal to a second threshold. When the second criterion is still acceptable, step 245 may further include determining whether plant disease exists based on a third criterion of the multispectral aerial image, side-view image, and value of chlorophyll b criteria. The first, second, and third criteria are different from each other.

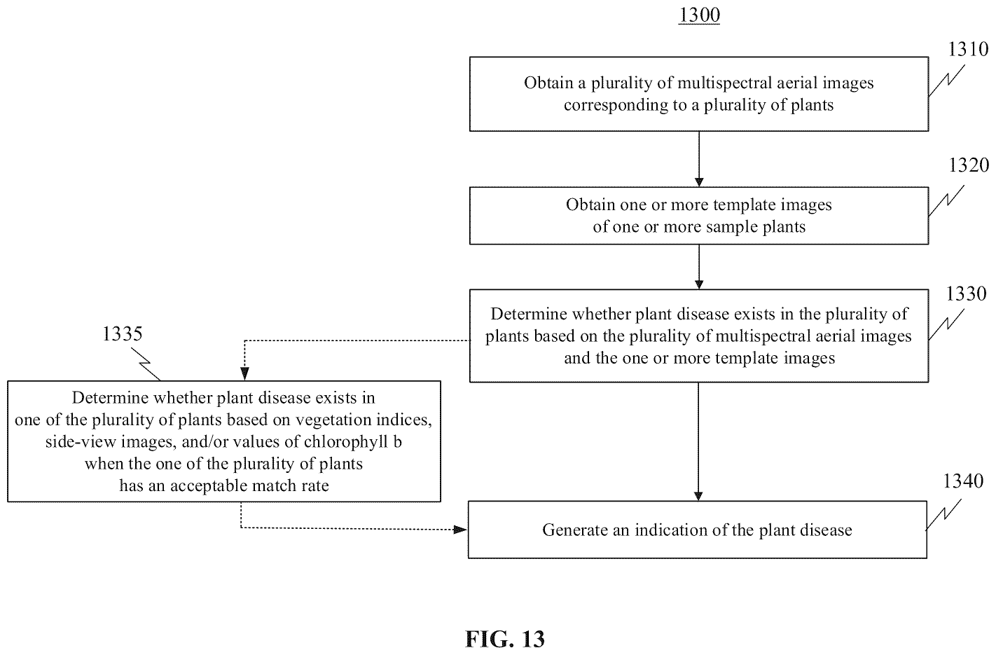

FIG. 13 is a flow chart of an exemplary method 1300 for detecting plant disease in an area, according to some embodiments of the present disclosure. Method 1300 may be practiced by apparatus 100 for detecting plant disease. Solely for illustrative purposes and without limitation, method 1300 is described with reference to an example of detecting disease in oil palm trees. However, method 1300 practiced by apparatus 100 is not so limited and can be implemented to detect plant disease in other types of plants. Method 1300 includes obtaining a plurality of multispectral aerial images corresponding to a plurality of plants (step 1310), obtaining one or more template images of one or more sample plants (step 1320), determining whether plant disease exists in the plurality of plants based on the multispectral aerial images and the one or more template images (step 1330), and generating an indication of the plant disease (step 1340). In addition, method 1300 may further include determining whether plant disease exists in one of the plurality of plants based on vegetation indices, side-view images, and/or values of chlorophyll b when the one of the plurality of plants has an acceptable vegetation index (step 1335). When method 1300 includes step 1335, step 1340 is performed after step 1335.

Step 1310 includes obtaining a plurality of multispectral aerial images corresponding to a plurality of plants. For example, UAV 110 (FIG. 1) is configured to capture the multispectral aerial images of the area by a multispectral camera. Processor 140 of apparatus 100 is configured to obtain an OSAVI image of the area (FIG. 4) based on the multispectral aerial image. The OSAVI image of the area contains GPS positions at all image pixels and image data, such as reflectance in red, green, blue, red edge, and near-infrared bands. As described above with reference to FIGS. 1-8, processor 140 is further configured to extract a plurality of OSAVI images corresponding to the plurality of plants, e.g., oil palm trees, based on the located GPS positions in the RGB image and multispectral aerial image of the area. Processor 140 is configured to crop a plurality of OSAVI images of 200 pixels from the OSAVI image of the area. The plurality of OSAVI images include, for example, OSAVI images of oil palm trees P6, P19, P27, P20, P5, P1, P18, P25, P2, P15, P22, P3, P21, P26, and P17 in FIG. 7 and OSAVI images of oil palm trees P8, P29, P30, P10, P24, P13, P28, P14, P12, P23, P9, P11, and P7 in FIG. 8.

In some embodiments, processor 140 of apparatus 100 is configured to obtain a plurality of OSAVI images corresponding to a plurality of oil palm trees from a database. The database is stored in, for example, memory 160 of apparatus 100 (FIG. 1) or a cloud storage server (not shown).

Step 1320 includes obtaining one or more template images of one or more sample plants. For example, processor 140 of apparatus 100 is configured to obtain an OSAVI image of a healthy oil palm tree as an OSAVI template image from memory 160 of apparatus 100 (FIG. 1) or a cloud storage server (not shown). As another example, processor 140 is configured to obtain a plurality of OSAVI images of healthy oil palm trees as a plurality of OSAVI template images from memory 160 of apparatus 100 (FIG. 1) or a cloud storage server (not shown).

Step 1330 includes determining whether plant disease exists in the plurality of plants based on the multispectral aerial images and the one or more template images. For example, processor 140 of apparatus 100 is configured to determine whether plant disease exists in the plurality of oil palm trees in the area based on the OSAVI images of oil palm trees (step 1310) and the one or more OSAVI template images (step 1320). If processor 140 is configured to obtain one OSAVI template image in step 1320, processor 140 is further configured to calculate a plurality of OSAVI match rates between the OSAVI aerial images of oil palm trees and the OSAVI template image from the healthy oil palm tree, based on the template matching method described above with reference to equation (1) and FIGS. 7 and 8. Processor 140 is further configured to determine whether plant disease exists in the oil palm trees based on the OSAVI match rates and a first OSAVI match threshold, as described above with reference FIGS. 7 and 8.

For example, oil palm tree P6 may have an OSAVI match rate of 85%, i.e., the calculated match rate between the OSAVI aerial image of oil palm tree P6 and the OSAVI template image of the healthy oil palm tree. Processor 140 is configured to compare the OSAVI match rate of oil palm tree P6 (85%) with an OSAVI match threshold, e.g., 80%. Processor 140 is further configured to determine that plant disease does not exist in oil palm tree P6 because the OSAVI match rate of oil palm tree P6 (85%) is greater than the OSAVI match threshold (80%). If an OSAVI match rate of one of the oil palm trees is greater than or equal to the OSAVI match threshold (80%), processor 140 is configured to determine that plant disease does not exist in the one of oil palm trees. As another example, oil palm tree P17 may have an OSAVI match rate of 45%. Processor 140 is configured to compare the OSAVI match rate of oil palm tree P17 (45%) with the OSAVI match threshold (80%). Processor 140 is further configured to determine that plant disease exists in oil palm tree P17 because the OSAVI match rate of oil palm tree P17 (45%) is less than the OSAVI match threshold (80%).

If processor 140 is configured to obtain a plurality of OSAVI images of healthy oil palm trees as a plurality of OSAVI template images, processor 140 is further configured to calculate a plurality of OSAVI match rates between the OSAVI aerial images of oil palm trees and each of the plurality of OSAVI template images from the healthy oil palm trees, based on the template matching method described above with reference to equation (1) and FIGS. 7 and 8. Processor 140 is further configured to determine whether plant disease exists in the oil palm trees based on the OSAVI match rates and a second OSAVI match threshold, as described above with reference FIGS. 7 and 8. When none of the OSAVI match rates between the OSAVI image of an oil palm tree and the plurality of OSAVI template images is greater than or equal to the second OSAVI match threshold, processor 140 is configured to determine plant disease exists in that oil palm tree. When at least one of the OSAVI match rates for the oil palm tree is greater than or equal to the second OSAVI match threshold, processor 140 is configured to determine plant disease does not exist in the oil palm tree. In some embodiments, when at least a number of the OSAVI match rates for the oil palm tree are greater than or equal to the second OSAVI match threshold, processor 140 is configured to determine plant disease does not exist in that oil palm tree. The number of the OSAVI match rates may be two, three, or any number less than or equal to a number of the plurality of OSAVI template images.

Step 1340 includes generating an indication of the plant disease. For example, processor 140 of apparatus 100 is configured to generate an indication of the plant disease upon determining that plant disease exists in particular ones of the plurality of plants. Thus, the indication includes information that plant disease exists in at least one of the plurality of plants, and which one(s) of the plurality of plants has the plant disease, as described above for method 200.

In some embodiments, the multispectral aerial images in step 1310 and the one or more template images in step 1320 are generated based on at least one of a plurality of normalized difference vegetation indices, or a plurality of soil-adjusted vegetation indices. For example, the OSAVI aerial images of the oil palm trees and the one or more OSAVI template images from the one or more healthy oil palm trees described above in steps 1310 and 1320 are generated based on soil-adjusted vegetation indices. As another example, processor 140 of apparatus 100 is configured to calculate an NDVI corresponding to each pixel of the multispectral aerial image of the area based on the NDVI formula and the image data of the multispectral image in red, green, blue, red edge, and near-infrared bands, as described above for step 230 of method 200 (FIG. 2). Processor 140 is configured to represent the NDVIs corresponding to the pixels of the multispectral aerial image of the area by a set of colors in an NDVI image of the area. Processor 140 is further configured to obtain a plurality of NDVI images of 200 pixels corresponding to the plurality oil palm trees from the NDVI image of the area based on the GPS positions, similar to the description of step 1310. Processor 140 is also configured to obtain one or more NDVI images of one or more healthy oil palm trees as one or more NDVI template images from memory 160 of apparatus 100 (FIG. 1) or a cloud storage server (not shown).

Step 1335 includes determining whether plant disease exists in one of the plurality of plants based on vegetation indices, side-view images, and/or values of chlorophyll b when the one of the plurality of plants has an acceptable vegetation index. Method 1300 may further include optional step 1335 as described in detail below.

In some embodiments of method 1300 including step 1335, the multispectral aerial images in step 1310 contain a plurality of image data in red, green, blue, red edge, and near-infrared bands. The match rates calculated in the embodiments above in step 1330 correspond to the plurality of plants. The match threshold is a first match threshold. Step 1335 includes identifying one of the plurality of plants corresponding to one of the match rates less than the first match threshold and equal to or greater than a second match threshold. The second match threshold is less than the first match threshold. In addition, step 1335 further includes determining a vegetation index corresponding to the one of the plurality of plants based on image data corresponding to the one of the plurality of plants and determining whether plant disease exists in the one of the plurality of plants based on the vegetation index and a disease threshold. That is, in these embodiments, step 1335 includes determining plant disease does not exist in a plant when the plant has an acceptable match rate (e.g., greater than or equal to the second match threshold) between the plant's OSAVI image and an OSAVI template image and has a vegetation index equal to or greater than the disease threshold. If one of the plurality of plants has a match rate less than the second match threshold, step 1335 further includes determining that plant disease exists in the one of the plurality of plants.

For example, the OSAVI aerial images of the oil palm trees (e.g., FIGS. 7 and 8) obtained in step 1310 contain a plurality of image data in red, green, blue, red edge, and near-infrared bands. The OSAVI match rates calculated in the embodiments above in step 1330 correspond to the plurality of oil palm trees in the area. The OSAVI match threshold of 80% is a first OSAVI match threshold. Processor 140 of apparatus 100 is configured to identify one of the oil palm trees corresponding to one of the calculated OSAVI match rates less than the first OSAVI match threshold (80%) and equal to or greater than a second OSAVI match threshold, e.g., 60%. The second OSAVI match threshold (60%) is less than the first OSAVI match threshold (80%). For example, processor 140 is configured to identify that oil palm tree P26 (FIG. 7) has an OSAVI match rate of 70%, which is less than the first OSAVI match threshold (80%) and equal to or greater than the second OSAVI match threshold (60%). That is, processor 140 is configured to identify that oil palm tree P26 has an acceptable match rate between the OSAVI image of oil palm tree P26 and the one or more OSAVI template images. Processor 140 is further configured to determine a mean OSAVI of 0.885593325 (FIG. 9) corresponding to oil palm tree P26 based on the image data in red, green, blue, red edge, and near-infrared bands, corresponding to oil palm tree P26. In addition, processor 140 is further configured to determine whether plant disease exists in oil palm tree P26 based on the mean OSAVI of 0.885593325 and an OSAVI disease threshold, e.g., 0.85. Processor 140 is configured to determine that plant disease does not exist in oil palm tree P26 because the mean OSAVI (0.885593325) of oil palm tree P26 is greater than the OSAVI disease threshold (0.85).

As another example, processor 140 is configured to identify that oil palm tree P23 (FIG. 8) has an OSAVI match rate of 66%, which is less than the first OSAVI match threshold (80%) and equal to or greater than the second OSAVI match threshold (60%). Processor 140 is further configured to determine a mean OSAVI of 0.79 (FIG. 10) corresponding to oil palm tree P23 based on the image data in red, green, blue, red edge, and near-infrared bands corresponding to oil palm tree P23. Processor 140 is configured to determine that plant disease exists in oil palm tree P23 because the mean OSAVI (0.79) of oil palm tree P23 is less than the OSAVI disease threshold (0.85).

If one of the plurality of oil palm trees has an OSAVI match rate less than the second OSAVI match threshold (60%), processor 140 is configured to determine that plant disease exists in the one of the plurality of oil palm trees.

In some embodiments of method 1300 including step 1335, the match rates calculated in the embodiments above in step 1330 correspond to the plurality of plants. The match threshold is a first match threshold. Step 1335 includes identifying one of the plurality of plants corresponding to one of the match rates less than the first match threshold and equal to or greater than a second match threshold. The second match threshold is less than the first match threshold. In addition, step 1335 further includes obtaining a side-view image of the one of the plurality of plants and determining whether plant disease exists in the one of the plurality of plants based on the side-view image and one or more side-view template images. That is, in these embodiments, step 1335 includes determining plant disease does not exist in a plant when the plant has an acceptable match rate between the plant's OSAVI image and has a side-view image matching the one or more healthy plant side-view template images to a predetermined degree. If one of the plurality of plants has a match rate less than the second match threshold, step 1335 further includes determining that plant disease exists in the one of the plurality of plants.

For example, the OSAVI match rates calculated in the embodiment above in step 1330 correspond to the plurality of oil palm trees in the area (FIG. 4). The OSAVI match threshold of 80% is a first OSAVI match threshold. Processor 140 of apparatus 100 is configured to identify one of the oil palm trees corresponding to one of the OSAVI match rates less than the first OSAVI match threshold (80%) and equal to or greater than a second OSAVI match threshold, e.g., 60%. The second OSAVI match threshold (60%) is less than the first OSAVI match threshold (80%). For example, processor 140 is configured to identify that oil palm tree P26 (FIG. 7) has a match rate of 70%, which is less than the first match threshold (80%) and equal to or greater than the second match threshold (60%). Processor 140 is further configured to obtain a side-view image of oil palm tree P26 and to determine whether plant disease exists in oil palm tree P26 based on the side-view image of oil palm tree P26.

Processor 140 is configured to determine that plant disease exists in oil palm tree P26 if the side view image of oil palm tree P26 contains at least one of a skirt-like crown of leaves, a mycelium, a fruiting body, a drooping frond, or a rotting trunk. Processor 140 may be configured to calculate a plurality of side-view match rates between the side-view image of oil palm tree P26 and a plurality of side-view template images of non-healthy oil palm trees, including unopened young leaves, necrosis in older leaves, a skirt-like crown with lower leaves, a white mycelium of Ganoderma, a fruiting body of Ganoderma, and/or a rotting trunk, as described above for method 200 with reference to FIGS. 2, 5, and 6. Because the side-view image of oil palm tree P26 (FIG. 5) does not include any of the above visual symptoms, the side-view match rates of oil palm tree P26 may be, e.g., 30%, 20%, 35%, 28%, 33%, and 25%, all of which are lower than a side-view match rate threshold, e.g., 60%. Accordingly, processor 140 is configured to determine that plant disease does not exist in oil palm tree P26.

As another example, processor 140 is configured to identify that oil palm tree P23 (FIG. 8) has an OSAVI match rate of 66%, which is less than the first OSAVI match threshold (80%) and equal to or greater than the second OSAVI match threshold (60%). Processor 140 is further configured to obtain a side-view image of oil palm tree P23 (image (c) in FIG. 6) and determine that a side-view match rate between the side-view image of oil palm tree P23 and a side-view template image of a rotting trunk (not shown) is 75%, which is greater than the side-view match rate threshold (60%). Processor 140 is configured to determine that plant disease exists in oil palm tree P23.

If one of the plurality of oil palm trees has an OSAVI match rate less than the second OSAVI match threshold (60%), processor 140 is configured to determine that plant disease exists in the one of the plurality of oil palm trees.

In some embodiments of method 1300 including step 1335, the match rates calculated in the embodiments above in step 1330 correspond to the plurality of plants. The match threshold is a first match threshold. Step 1335 includes identifying one of the plurality of plants corresponding to one of the match rates less than the first match threshold and equal to or greater than a second match threshold. The second match threshold is less than the first match threshold. In addition, step 1335 further includes obtaining a value of chlorophyll b content in a leaf of the one of the plurality of plants and determining whether plant disease exists in the one of the plurality of plants based on the value of chlorophyll b content and a disease threshold. That is, in these embodiments, step 1335 includes determining plant disease does not exist in a plant when the plant has an acceptable match rate between the plant's OSAVI image and an OSAVI template image and has a value of chlorophyll b content greater than or equal to a disease threshold. If one of the plurality of plants has a match rate less than the second match threshold, step 1335 further includes determining that plant disease exists in the one of the plurality of plants.

For example, the match rates calculated in the embodiments above in step 1330 correspond to the plurality of oil palm trees in the area (FIG. 4). The OSAVI match threshold of 80% is a first OSAVI match threshold. Processor 140 of apparatus 100 is configured to identify one of the oil palm trees corresponding to one of the OSAVI match rates less than the first OSAVI match threshold (80%) and equal to or greater than a second OSAVI match threshold, e.g., 60%. The second OSAVi match threshold (60%) is less than the first OSAVi match threshold (80%). For example, processor 140 is configured to identify that oil palm tree P26 (FIG. 7) has an OSAVI match rate of 70% less than the first OSAVI match threshold (80%) and equal to or greater than the second OSAVI match threshold (60%).

Processor 140 is further configured to obtain a value of chlorophyll b (Cb) content (29.63 μg/ml in FIG. 11) in a leaf of oil palm tree P26 and to determine whether plant disease exists in oil palm tree P26 based on the value of chlorophyll b content (29.63 μg/ml) and a Cb disease threshold of, e.g., 25 μg/ml. Processor 140 is configured to compare the value of Cb content of oil palm tree P26 (29.63 μg/ml) with the Cb disease threshold (25 μg/ml) and determine that plant disease does not exist in oil palm tree P26 because oil palm tree P26 has the value of Cb content (29.63 μg/ml) higher than the Cb disease threshold (25 μg/ml).

As another example, processor 140 is configured to identify that oil palm tree P13 (FIG. 8) has a match rate of 66%, which is less than the first match threshold (80%) and equal to or greater than the second match threshold (60%). Processor 140 is further configured to determine that plant disease exists in oil palm tree P13 because oil palm tree P13 has a Cb value of 24.67 μg/ml, which is lower than the Cb disease threshold (25 μg/ml).

If one of the plurality of oil palm trees has an OSAVI match rate less than the second OSAVI match threshold (60%), processor 140 is configured to determine that plant disease exists in the one of the plurality of oil palm trees.

In some of the above embodiments performing step 1335 to determine whether plant disease exists based on a first one of the vegetation index, side-view image, and value of chlorophyll b, step 1335 may further include determining whether plant disease exists based on a second one of the vegetation index, side-view image, and value of chlorophyll b criteria when the first criterion is acceptable, i.e., less than a first threshold but greater or equal to a second threshold. When the second criterion is still acceptable, step 1335 may further include determining whether plant disease exists based on a third one of the vegetation index, side-view image, and value of chlorophyll b criteria. The first, second, and third criteria are different from each other.

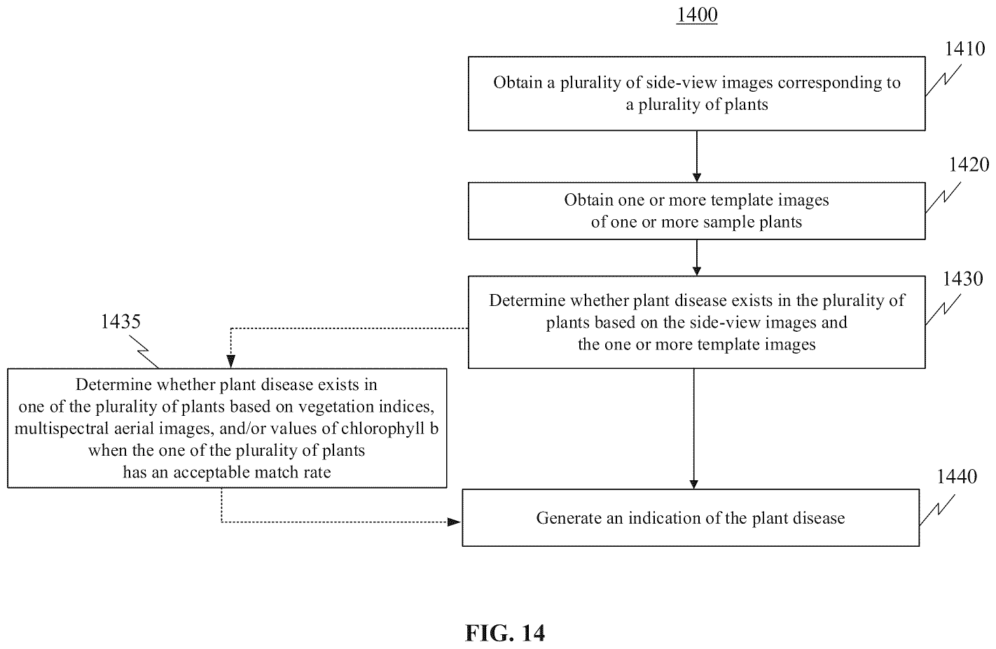

FIG. 14 is a flow chart of an exemplary method 1400 for detecting plant disease in an area, according to some embodiments of the present disclosure. Method 1400 may be practiced by apparatus 100 for detecting plant disease. Solely for illustrative purposes and without limitation, method 1400 is described with reference to an example of detecting disease in oil palm trees. However, method 1400 practiced by apparatus 100 is not so limited and can be implemented to detect plant disease in other types of plants. Method 1400 includes obtaining a plurality of side-view images corresponding to a plurality of plants (step 1410), obtaining one or more template images of one or more sample plants (step 1420), determining whether plant disease exists in the plurality of plants based on the side-view images and the one or more template images (step 1430), and generating an indication of the plant disease (step 1440). In addition, method 1400 may further include determining whether plant disease exists in one of the plurality of plants based on vegetation indices, multispectral aerial images, and/or values of chlorophyll b when the one of the plurality of plants has an acceptable match rate (step 1435). When method 1400 includes step 1435, step 1440 is performed after step 1435.

Step 1410 includes obtaining a plurality of side-view images corresponding to a plurality of plants. For example, processor 140 of apparatus 100 is configured to obtain the side-view images of oil palm trees from the UGV, which takes side-view images of oil palm trees in the area of FIG. 3. Processor 140 may also be configured to associate the side-view images of oil palm trees with oil palm trees in the area in accordance with the GPS positions recorded by the UGV and UAV 110.

Step 1420 includes obtaining one or more template images of one or more sample plants. For example, processor 140 of apparatus 100 is configured to obtain a side-view image of a healthy oil palm tree as a side-view template image from memory 160 of apparatus 100 (FIG. 1) or a cloud storage server (not shown). As another example, processor 140 of apparatus 100 is configured to obtain a plurality of side-view images of healthy oil palm trees as a plurality of side-view template images from memory 160 of apparatus 100 (FIG. 1) or a cloud storage server (not shown).

Step 1430 includes determining whether plant disease exists in the plurality of plants based on the side-view images and the one or more template images. For example, when processor 140 of apparatus 100 is configured to obtain one side-view template image in step 1420, processor 140 is configured to determine whether plant disease exists in the plurality of oil palm trees in the area based on the side-view images of the oil palm trees and the side-view template image of a healthy oil palm tree by calculating a plurality of side-view match rates between the side-view images of the oil palm trees and the side-view template image using a template matching method, such as the method described with reference to equation (1). Processor 140 is further configured to determine whether plant disease exists in the oil palm trees based on the side-view match rates and a first side-view match threshold, e.g., 70%. If a side-view match rate corresponding to one of the oil palm trees is less than the first side-view match threshold of 70%, processor 140 is configured to determine that plant disease exists in the one of the oil palm trees. If the side-view match rate corresponding to the one of the oil palm trees is equal to or greater than the side-view match threshold of 70%, processor 140 is configured to determine that plant disease does not exist in the one of the oil palm trees.

As another example, when processor 140 of apparatus 100 is configured to obtain a plurality of side-view images of healthy oil palm trees as a plurality of side-view template images, processor 140 is configured to calculate a plurality of side-view match rates between the side-view images of oil palm trees and each of the plurality of side-view template images of the healthy oil palm trees, based on the template matching method described above with reference to equation (1). Processor 140 is further configured to determine whether plant disease exists in the oil palm trees based on the side-view match rates and a second side-view match threshold. When none of the side-view match rates between the side-view image of an oil palm tree and the plurality of side-view template images is greater than or equal to the second side-view match threshold, processor 140 is configured to determine plant disease exists in an oil palm tree. When at least one of the side-view match rates for the oil palm tree is greater than or equal to the second side-view match threshold, processor 140 is configured to determine plant disease does not exist in the oil palm tree. In some embodiments, when at least a number of the side-view match rates for the oil palm tree are greater than or equal to the second side-view match threshold, processor 140 is configured to determine plant disease does not exist in the oil palm tree. The number of the side-view match rates may be two, three, or any number less than or equal to a number of the plurality of side-view template images.

Step 1440 includes generating an indication of plant disease. For example, processor 140 of apparatus 100 is configured to generate an indication of plant disease upon determining that plant disease exists in particular ones of the plurality of plants. Thus, the indication includes information that plant disease exists in at least one of the plurality of plants, and which one(s) of the plurality of plants has the plant disease, as described above for method 200.

In some embodiments, the one or more template images in step 1420 include one or more symptoms of disease. Determining whether plant disease exists in the plurality of plants based on the side-view images and the one or more template images in step 1430 includes calculating a plurality of side-view match rates between the side-view images of the oil palm trees and the one or more plant disease side-view template images, and determining whether plant disease exists in the plurality of plants based on the side-view match rates and a side-view symptom match threshold. Determining whether plant disease exists in the plurality of plants based on the side-view match rates and the side-view symptom match threshold includes determining that plant disease exists in one of the plurality of plants when the side-view match rate corresponding to the one of the plurality of plants is equal to or greater than the side-view symptom match threshold. Determining whether plant disease exists in the plurality of plants also includes determining that plant disease does not exist in the one of the plurality of plants when the side-view match rate corresponding to the one of the plurality of plants is less than the side-view symptom match threshold.

For example, one or more side-view template images of one or more sample oil palm trees with disease symptoms may include a skirt-like crown of leaves, a mycelium, a fruiting body, a drooping frond, or a rotting trunk, such as shown in side-view images of oil palm trees P11, P14, and P23 in images (c), (d), and (e) in FIG. 6. Processor 140 of apparatus 100 is configured to determine whether plant disease exists in a plurality of oil palm trees in an area by calculating a plurality of symptom match rates between side-view images of the oil palm trees and the one or more side-view template images with disease symptoms based on a template matching method, such as the method described with reference to equation (1). If a symptom match rate corresponding to one of the oil palm trees is equal to or greater than a side-view symptom match threshold, e.g., 75%, processor 140 is configured to determine that plant disease exists in the one of the oil palm trees. If the symptom match rate corresponding to the one of the oil palm trees is less than the side-view symptom match threshold (75%), processor 140 is configured to determine that plant disease does not exist in the one of the oil palm trees.

In some embodiments, as noted above, the one or more template images in step 1420 include a plurality of side-view template images containing a plurality of disease symptoms of a plant. For example, each side-view template image contains one of the disease symptoms. Determining whether plant disease exists in the plurality of plants in step 1430 includes determining whether plant disease exists in one of the plurality of plants based on a number of disease symptoms detected in the one of the plurality of plants.

For example, processor 140 of apparatus 100 is configured to detect if the side-view image of an oil palm tree contains one or more of the disease symptoms by template matching the side-view image of the oil palm tree with the plurality of side-view template images each containing a different one of the disease symptoms. Processor 140 is further configured to determine plant disease exists in the oil palm tree when a number of detected disease symptoms is equal to or greater than a symptom number threshold. The symptom number threshold may be, for example, one, two, three, or any number less than a number of the plurality side-view template images. When the side-view image of the oil palm tree is detected to have a number of symptoms that is equal to or greater than the symptom number threshold, processor 140 is configured to determine that plant disease exists in the oil palm tree. When the side-view image of the oil palm tree is detected to have a number of the disease symptoms less than the symptom number threshold, processor 140 is configured to determine that plant disease does not exist in the oil palm tree.

Step 1435 includes determining whether plant disease exists in one of the plurality of plants based on vegetation indices, multispectral aerial images, and/or values of chlorophyll b when the one of the plurality of plants has an acceptable match rate. Method 1400 may further include optional step 1435 as described in detail below.

In some embodiments of method 1400 including step 1435, the plurality of side-view match rates calculated in the embodiments of step 1430 correspond to the plurality of plants. The side-view match threshold is a first match threshold. Step 1435 includes identifying one of the plurality of plants corresponding to one of the side-view match rates less than the first match threshold and equal to or greater than a second match threshold. The second match threshold is less than the first match threshold. The operations of method 1400 further comprise obtaining image data in red, green, blue, red edge, and near-infrared bands, corresponding to the identified one of the plurality of plants. Step 1435 also includes determining a vegetation index corresponding to the one of the plurality of plants based on the image data corresponding to the identified one of the plurality of plants, and determining whether plant disease exists in the one of the plurality of plants based on the vegetation index and a disease threshold. That is, in these embodiments, step 1435 includes determining plant disease does not exist in a plant when the plant has an acceptable side-view match rate and a vegetation index equal to or greater than the disease threshold. If one of the plurality of plants has a side-view match rate less than the second match threshold, method 1400 further includes determining that plant disease exists in the one of the plurality of plants.

For example, the side-view match rates calculated in the embodiments of step 1430 correspond to the oil palm trees in an area. The side-view match threshold of 70% is a first match threshold. Processor 140 of apparatus 100 is configured to identify one of the oil palm trees corresponding to one of the side-view match rates less than the first match threshold (70%) and equal to or greater than a second match threshold, e.g., 60%. The second match threshold (60%) is less than the first match threshold (70%). For example, processor 140 is configured to identify that oil palm tree P1 (FIG. 5) has a side-view match rate of 65%. The side-view match rate of 65% is less than the first match threshold (70%) and greater than the second match threshold (60%). Processor 140 is configured to obtain image data in red, green, blue, red edge, and near-infrared bands, corresponding to oil palm tree P1 from, for example, the image data contained in the OSAVI image in FIG. 4. Processor 140 is further configured to determine an OSAVI of 0.920747403 (FIG. 9) corresponding to oil palm tree P1 based on the image data in red, green, blue, red edge, and near-infrared bands. In addition, processor 140 is further configured to determine whether plant disease exists in oil palm tree P1 based on the OSAVI of 0.920747403 and an OSAVI disease threshold, e.g., 0.85. Processor 140 is configured to determine that plant disease does not exist in oil palm tree P26 because the OSAVI (0.920747403) of oil palm tree P1 is greater than the OSAVI disease threshold (0.85).

As another example, processor 140 is further configured to identify that oil palm tree P23 (FIG. 8) has a side-view match rate of 66%, which is less than the first match threshold (70%) and equal to or greater than the second match threshold (60%). Processor 140 is further configured to determine an OSAVI of 0.79 (FIG. 10) corresponding to oil palm tree P23 based on the image data in red, green, blue, red edge, and near-infrared bands. Processor 140 is configured to determine that plant disease exists in oil palm tree P23 because the OSAVI (0.79) of oil palm tree P23 is less than the OSAVI disease threshold (0.85).

If one of the plurality of oil palm trees has a side-view match rate less than the second match threshold (60%), processor 140 is configured to determine that plant disease exists in the one of the plurality of oil palm trees.

In some embodiments of method 1400 including step 1435, the plurality of side-view match rates calculated in the embodiments of step 1430 correspond to the plurality of plants. The one or more template images are one or more first template images. The match threshold is a first match threshold. Step 1435 includes identifying one of the plurality of plants corresponding to one of the side-view match rates less than the first match threshold and equal to or greater than a second match threshold. The second match threshold is less than the first match threshold. Step 1435 further includes obtaining a multispectral aerial image corresponding to the one of the plurality of plants and obtaining one or more second template images. Step 1435 further includes determining whether plant disease exists in the one of the plurality of plants based on the multispectral aerial image and the one or more second template images. That is, in these embodiments, step 1435 includes determining plant disease does not exist in a plant when the plant has an acceptable side-view match rate and a multispectral match rate equal to or greater than a third match threshold. If one of the plurality of plants has a side-view match rate less than the second match threshold, method 1400 further includes determining that plant disease exists in the one of the plurality of plants.

For example, the side-view match rates calculated in the embodiments of step 1430 correspond to the plurality of oil palm trees in the area. The one or more side-view template images of healthy or non-healthy oil palm tree are one or more first template images. The side-view match threshold of 70% is a first match threshold. Processor 140 of apparatus 100 is configured to identify one of the oil palm trees corresponding to one of the side-view match rates less than the first match threshold (70%) and equal to or greater than a second match threshold, e.g., 60%. The second match threshold (60%) is less than the first match threshold (70%). For example, processor 140 is configured to identify that oil palm tree P1 (FIG. 5) has a side-view match rate of 65%, which is less than the first match threshold (70%) and equal to or greater than the second match threshold (60%). Processor 140 is further configured to obtain an OSAVI image of oil palm tree P1 (FIG. 7) and obtain an OSAVI template image of a healthy oil palm tree as a second template image. Processor 140 is configured to determine whether plant disease exists in oil palm tree P1 based on the OSAVI image of oil palm tree P1 and the OSAVI template image of the healthy oil palm tree. For example, processor 140 is configured to calculate a match rate between the OSAVI image of oil palm tree P1 and the OSAVI template image. Processor 140 is configured to compare the match rate (e.g., 82%) of oil palm tree P1 with a match threshold, e.g., 80%. Processor 140 is further configured to determine that plant disease does not exist in oil palm tree P1 because the match rate of oil palm tree P1 (82%) is equal to or greater than the match threshold (80%). As another example, if a match rate corresponding to an oil palm tree is 45%, processor 140 is configured to compare the match rate (45%) with the match threshold (80%) and determine that plant disease exists in the oil palm tree because the match rate (45%) is less than the match threshold (80%). In some embodiments, processor 140 is configured to obtain a plurality of OSAVI template images of a plurality of healthy oil palm trees as a plurality of second template images. Processor 140 is configured to determine whether plant disease exists in oil palm tree P1 based on a plurality of match rates between the OSAVI image of oil palm tree P1 and the plurality of OSAVI template images, similar to the description above for the example with one or more second template images.

If one of the plurality of oil palm trees has a side-view match rate less than the second match threshold (60%), processor 140 is configured to determine that plant disease exists in the one of the plurality of oil palm trees.

In some embodiments of method 1400 including step 1435, the plurality of side-view match rates calculated in the embodiments of step 1430 correspond to the plurality of plants. The match threshold is a first match threshold. The operations of method 1400 further comprise identifying one of the plurality of plants corresponding to one of the side-view match rates less than the first match threshold and equal to or greater than a second match threshold. The second match threshold is less than the first match threshold. The operations of method 1400 further comprise obtaining a value of chlorophyll b content in a leaf of the one of the plurality of plants and determining whether plant disease exists in the one of the plurality of plants based on the value of chlorophyll b content and a disease threshold. That is, in these embodiments, step 1435 includes determining plant disease does not exist in a plant when the plant has an acceptable side-view match rate and a value of chlorophyll b content greater than or equal to the disease threshold. If one of the plurality of plants has a side-view match rate less than the second match threshold, step 1435 further includes determining that plant disease exists in the one of the plurality of plants.

For example, the side-view match rates calculated in the embodiments of step 1430 correspond to the oil palm trees in the area. The side-view match threshold of 70% is a first match threshold. Processor 140 of apparatus 100 is configured to identify one of the oil palm trees corresponding to one of the side-view match rates less than the first match threshold (70%) and equal to or greater than a second match threshold, e.g., 60%. The second match threshold (60%) is less than the first match threshold (70%). For example, processor 140 is configured to identify that oil palm tree P26 (FIG. 5) has a side-view match rate of 65%, which is less than the first match threshold (70%) and equal to or greater than the second match threshold (60%). Processor 140 is further configured to obtain a value of chlorophyll b (Cb) content in a leaf of oil palm tree P26 and to determine whether plant disease exists in oil palm tree P26 based on the value of chlorophyll b content and a Cb disease threshold of, e.g., 25 μg/ml. Processor 140 is configured to compare the value (29.63 μg/ml in FIG. 11) of Cb content of oil palm tree P26 with the Cb disease threshold (25 μg/ml) and determine that plant disease does not exist in oil palm tree P26 because oil palm tree P26 has the value of Cb content (29.63 μg/ml) higher than the Cb disease threshold (25 μg/ml).

As another example, processor 140 is configured to identify that oil palm tree P11 (FIG. 6) has a side-view match rate of 66%, which is less than the first match threshold (70%) and equal to or greater than the second match threshold (60%). Processor 140 is further configured to determine that plant disease exists in oil palm trees P11 because oil palm tree P11 has a Cb value of 13.83 μg/ml (FIG. 12), which is lower than the Cb disease threshold (25 μg/ml).

If one of the plurality of oil palm trees has a side-view match rate less than the second match threshold (60%), processor 140 is configured to determine that plant disease exists in the one of the plurality of oil palm trees.

In some of the above embodiments performing step 1435 to determine whether plant disease exists based on a first one of the vegetation index, multispectral aerial image, and value of chlorophyll b criteria, step 1435 may further include determining whether plant disease exists based on a second one of the vegetation index, multispectral aerial image, and value of chlorophyll b criteria when the first criterion is acceptable, i.e., less than a first threshold but greater or equal to a second threshold. When the second criterion is still acceptable, step 1435 may further include determining whether plant disease exists based on a third one of the vegetation index, multispectral aerial image, and value of chlorophyll b criteria. The first, second, and third criteria are different from each other.

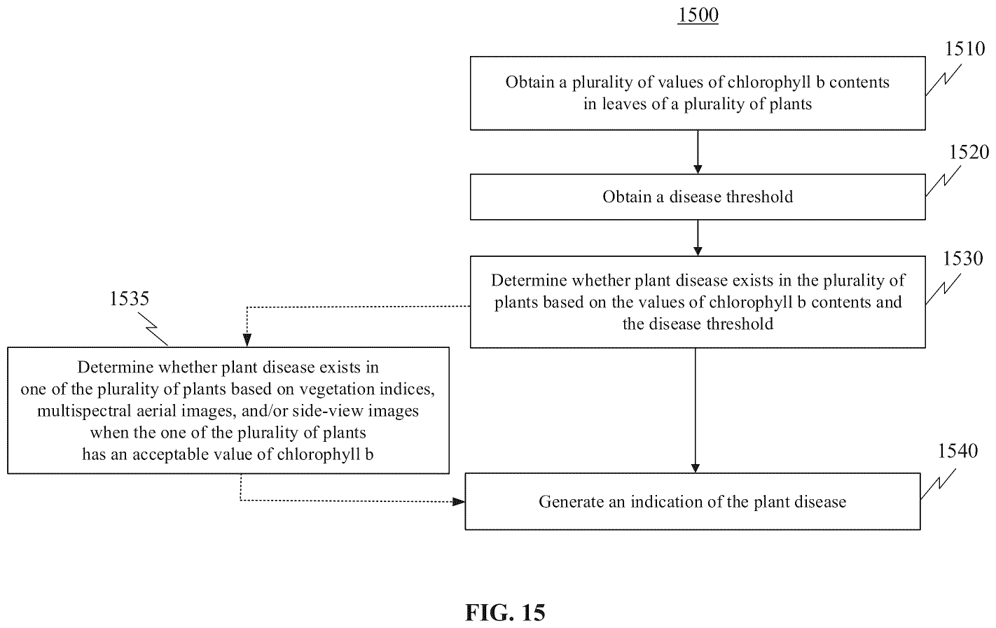

FIG. 15 is a flow chart of an exemplary method 1500 for detecting plant disease in an area, according to some embodiments of the present disclosure. Method 1500 may be practiced by apparatus 100 for detecting plant disease. Solely for illustrative purposes and without limitation, method 1500 is described with reference to an example of detecting disease in oil palm trees. However, method 1500 practiced by apparatus 100 is not so limited and can be implemented to detect plant disease in other types of plants. Method 1500 includes obtaining a plurality of values of chlorophyll b contents in leaves of a plurality of plants (step 1510), obtaining a disease threshold (step 1520), determining whether plant disease exists in the plurality of plants based on the values of chlorophyll b contents and the disease threshold (step 1530), and generating an indication of the plant disease (step 1540). In addition, method 1500 may further include determining whether plant disease exists in one of the plurality of plants based on vegetation indices, multispectral aerial images, and/or side-view images when the one of the plurality of plants has an acceptable value of chlorophyll b (step 1535). When method 1500 includes step 1535, step 1540 is performed after step 1535.

Step 1510 includes obtaining a plurality of values of chlorophyll b contents in leaves of a plurality of plants. For example, processor 140 of apparatus 100 is configured to obtain a plurality of values of chlorophyll b (Cb) contents in leaves of the oil palm trees in the area from, for example, MINOLTA SPAD-502 and Agilent Chlorophyll and Carotenoid measurement machines, via user interface 114 (FIG. 1).

Step 1520 includes obtaining a disease threshold. For example, processor 140 of apparatus 100 is configured to obtain a Cb disease threshold of, e.g., 25 μg/ml, from memory 160 of apparatus 100 (FIG. 1) or a cloud storage server (not shown). In some embodiments, processor 140 is configured to obtain a plurality of Cb disease thresholds from memory 160 of apparatus 100 (FIG. 1) or a cloud storage server (not shown).

Step 1530 includes determining whether plant disease exists in the plurality of plants based on the values of chlorophyll b contents and the disease threshold. For example, processor 140 of apparatus 100 is configured to determine whether plant disease exists in the oil palm trees in the area based on the values of chlorophyll b contents and the Cb disease threshold of, e.g., 25 μg/ml. For example, processor 140 is configured to compare a value (29.63 μg/ml in FIG. 11) of Cb content of oil palm tree P26 with the Cb disease threshold (25 μg/ml) and determine that plant disease does not exist in oil palm tree P26 because oil palm tree P26 has the value of Cb content (29.63 μg/ml) equal to or greater than the Cb disease threshold (25 μg/ml). As another instance, processor 140 is configured to compare a value (24.67 μg/ml in FIG. 12) of Cb content of oil palm tree P13 with the Cb disease threshold (25 μg/ml) and determine that plant disease exists in oil palm tree P13 because oil palm tree P13 has the value of Cb content (24.67 μg/ml) less than the Cb disease threshold (25 μg/ml).

Step 1540 includes generating an indication of plant disease. For example, processor 140 of apparatus 100 is configured to generate an indication of plant disease upon determining that plant disease exists in particular ones of the plurality of plants. Thus, the indication includes information that plant disease exists in at least one of the plurality of plants, and which one(s) of the plurality of plants has the plant disease, as described above for method 200.

In some embodiments, method 1500 further includes, in response to a determination that plant disease exists in one of the plurality of plants, obtaining a side-view image of the one of the plurality of plants and determining whether the plant disease is Ganoderma disease based on the side-view image. When the side-view image of the one of the plurality of plants includes at least one of a skirt-like crown of leaves, a mycelium, a fruiting body, a drooping frond, or a rotting trunk, determining whether the plant disease is Ganoderma disease in method 1500 includes determining the plant disease is Ganoderma disease, as described above for method 200 with reference to FIGS. 5 and 6.

Step 1535 includes determining whether plant disease exists in one of the plurality of plants based on vegetation indices, multispectral aerial images, and/or side-view images when the one of the plurality of plants has an acceptable value of chlorophyll b. Method 1500 may further optional include step 1535 as described in detail below.

In some embodiments of method 1500 including step 1535, the plurality of values of chlorophyll b contents in step 1510 correspond to the plurality of plants. The Cb disease threshold in step 1520 is a first disease threshold. Method 1500 further includes identifying one of the plurality of plants corresponding to one of the values of chlorophyll b content less than the first disease threshold and equal to or greater than a second disease threshold. The second disease threshold is less than the first disease threshold. Method 1500 also includes obtaining a side-view image of the one of the plurality of plants and determining whether plant disease exists in the one of the plurality of plants based on the side-view image and one or more side-view template images. That is, in these embodiments, step 1535 includes determining plant disease does not exist in a plant when the plant has an acceptable value of chlorophyll b content and has a side-view image matching the one or more side-view template images to a predetermined degree. If one of the plurality of plants has a value of chlorophyll b content less than the second disease threshold, step 1535 further includes determining that plant disease exists in the one of the plurality of plants.

For example, the values of chlorophyll b contents obtained by apparatus 100 in the embodiments of step 1510 correspond to the oil palm trees in the area. The Cb disease threshold of 25 μg/ml obtained by apparatus 100 in the example of step 1520 is a first disease threshold. Processor 140 of apparatus 100 is configured to identify oil palm tree P13 having the Cb content of 24.67 μg/ml less than the first Cb disease threshold (25 μg/ml) and equal to or greater than a second Cb disease threshold, e.g., 20 μg/ml. The second Cb disease threshold (20 μg/ml) is less than the first Cb disease threshold (25 μg/ml).

Processor 140 is further configured to obtain a side-view image of oil palm tree P13 and determine whether plant disease exists in the one of the plurality of plants based on the side-view image. For example, processor 140 is configured to determine that plant disease exists in oil palm tree P13 if the side view image of oil palm tree P13 contains at least one of a skirt-like crown of leaves, a mycelium, a fruiting body, a drooping frond, or a rotting trunk. Processor 140 may be configured to compare the side-view images of oil palm tree P26 with a plurality of side-view template images of non-healthy oil palm trees, including unopened young leaves, necrosis in older leaves, a skirt-like crown with lower leaves, a white mycelium of Ganoderma, a fruiting body of Ganoderma, and/or a rotting trunk, as described above for method 200 with reference to FIGS. 2, 5, and 6. If the side-view image of oil palm tree P13 does not contain any of a skirt-like crown of leaves, a mycelium, a fruiting body, a drooping frond, or a rotting trunk, processor 140 is configured to determine that plant disease does not exist in oil palm tree P13.

If one of the plurality of oil palm trees has a value of chlorophyll b content less than the second Cb disease threshold (20 μg/ml), processor 140 is configured to determine that plant disease exists in the one of the plurality of oil palm trees.

In some embodiments of method 1500 including step 1535, the plurality of values of chlorophyll b contents in step 1510 correspond to the plurality of plants. The Cb disease threshold in step 1520 is a first disease threshold. Method 1500 further includes identifying one of the plurality of plants corresponding to one of the values of chlorophyll b content less than the first disease threshold and equal to or greater than a second disease threshold. The second disease threshold is less than the first disease threshold. Method 1500 also includes obtaining image data in red, green, blue, red edge, and near-infrared bands, corresponding to the one of the plurality of plants. Method 1500 further includes determining a vegetation index based on the image data and determining whether plant disease exists in the one of the plurality of plants based on the vegetation index and a third disease threshold. That is, in these embodiments, step 1535 includes determining plant disease does not exist in a plant when the plant has an acceptable value of chlorophyll b content and has a vegetation index greater than or equal to the third disease threshold. If one of the plurality of plants has a value of chlorophyll b content less than the second disease threshold, step 1535 further includes determining that plant disease exists in the one of the plurality of plants.

For example, the values of chlorophyll b contents obtained by apparatus 100 in the embodiments of step 1510 correspond to the oil palm trees in the area. The Cb disease threshold of 25 μg/ml obtained by apparatus 100 in the example of step 1520 is a first disease threshold. Processor 140 of apparatus 100 is configured to identify oil palm tree P13 having the Cb content of 24.67 μg/ml less than the Cb disease threshold (25 μg/ml) and equal to or greater than a second Cb disease threshold, e.g., 20 μg/ml. The second Cb disease threshold (20 μg/ml) is less than the first Cb disease threshold (25 μg/ml). Processor 140 is further configured to obtain image data in red, green, blue, red edge, and near-infrared bands, corresponding to oil palm tree P13 from, e.g., the OSAVI image in FIG. 4. Processor 140 is further configured to determine an OSAVI of 0.822 (FIG. 8) corresponding to oil palm tree P13 based on the image data in red, green, blue, red edge, and near-infrared bands, corresponding to oil palm tree P13. Processor 140 of apparatus 100 is further configured to determine whether plant disease exists in oil palm tree P13 based on the OSAVI of 0.822 and an OSAVI disease threshold, e.g., 0.8. Processor 140 is configured to determine that plant disease does not exist in oil palm tree P13 because the OSAVI (0.822) of oil palm tree P13 is greater than the OSAVI disease threshold (0.8).

As another example, processor 140 of apparatus 100 is configured to identify oil palm tree P1 having the Cb content of 20.9 μg/ml less than the Cb disease threshold (25 μg/ml) and equal to or greater than a second Cb disease threshold, e.g., 20 μg/ml. Processor 140 is configured to obtain image data in red, green, blue, red edge, and near-infrared bands, corresponding to oil palm tree P11 from, e.g., the OSAVI image in FIG. 4. Processor 140 is further configured to determine an OSAVI of 0.92 (FIG. 9) corresponding to oil palm tree P1 based on the image data in red, green, blue, red edge, and near-infrared bands, corresponding to oil palm tree P1. Processor 140 is configured to determine that plant disease does not exist in oil palm tree P1 because the OSAVI (0.92) of oil palm tree P1 is less than the OSAVI disease threshold (0.8).

If one of the plurality of oil palm trees has a value of chlorophyll b content less than the second Cb disease threshold (20 μg/ml), processor 140 is configured to determine that plant disease exists in the one of the plurality of oil palm trees.

In some embodiments of method 1500 including step 1535, the plurality of values of chlorophyll b contents in step 1510 correspond to the plurality of plants. The Cb disease threshold in step 1520 is a first disease threshold. Method 1500 further includes identifying one of the plurality of plants corresponding to one of the values of chlorophyll b content less than the first disease threshold and equal to or greater than a second disease threshold. The second disease threshold is less than the first disease threshold. Method 1500 also includes obtaining a multispectral aerial image corresponding to the one of the plurality of plants and obtaining one or more template images of one or more sample plants. Method 1500 further includes determining whether plant disease exists in the one of the plurality of plants based on the multispectral aerial image and the one or more template images. That is, in these embodiments, step 1535 includes determining plant disease does not exist in a plant when the plant has an acceptable value of chlorophyll b content and a multispectral match rate equal to or greater than a match threshold. If one of the plurality of plants has a value of chlorophyll b content less than the second disease threshold, step 1535 further includes determining that plant disease exists in the one of the plurality of plants.

For example, the values of chlorophyll b contents obtained by apparatus 100 in the embodiments of step 1510 correspond to the plurality of oil palm trees in the area. The Cb disease threshold of 25 μg/ml obtained by apparatus 100 in the example of step 1520 is a first disease threshold. Processor 140 of apparatus 100 is configured to identify oil palm tree P13 having the Cb content of 24.67 μg/ml less than the Cb disease threshold (25 μg/ml) and equal to or greater than a second Cb disease threshold, e.g., 20 μg/ml. The second Cb disease threshold (20 μg/ml) is less than the first Cb disease threshold (25 μg/ml). Processor 140 is further configured to obtain an OSAVI image of oil palm tree P13 (FIG. 8) and obtain an OSAVI image of a healthy oil palm tree as a template image. Processor 140 is configured to determine whether plant disease exists in oil palm tree P13 based on the OSAVI image of oil palm tree P13 and the OSAVI template image from the healthy oil palm tree. For example, processor 140 is configured to calculate a match rate between the OSAVI image of oil palm tree P13 and the OSAVI template image. Processor 140 is configured to compare the match rate of oil palm tree P13 (e.g., 85%) with a match threshold, e.g., 80%. Processor 140 is configured to determine that plant disease does not exist in oil palm tree P13 because the match rate of oil palm tree P13 (85%) is equal to or greater than the match threshold (80%). If a match rate corresponding to an oil palm tree is 60%, processor 140 is configured to compare the match rate (60%) with the match threshold (80%) and determine that plant disease exists in the oil palm tree because the match rate (60%) is less than the match threshold (80%).

If one of the plurality of oil palm trees has a value of chlorophyll b content less than the second Cb disease threshold (20 μg/ml), processor 140 is configured to determine that plant disease exists in the one of the plurality of oil palm trees.

In some of the above embodiments of step 1535 determining whether plant disease exists based on a first one of the vegetation index, multispectral aerial image, and side-view image criteria, step 1535 may further include determining whether plant disease exists based on a second one of the vegetation index, multispectral aerial image, and side-view image criteria when the first criterion is acceptable, i.e., less than a first threshold but greater or equal to a second threshold. When the second criterion is still acceptable, step 1535 may further include determining whether plant disease exists based on a third one of the vegetation index, multispectral aerial image, and side-view image criteria. The first, second, and third criteria are different from each other.

Another aspect of the disclosure is directed to a non-transitory computer-readable medium storing instructions which, when executed, cause one or more computers to perform the methods discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

The present disclosure is also related to features described in the following numbered embodiments (“E”). The numbered embodiments are illustrated and described according to some embodiments of the present disclosure.

E1. Apparatus for detecting plant disease in an area, the apparatus comprising: a memory storing instructions; and at least one processor configured to execute the instructions to perform operations comprising:
obtaining a red-green-blue (RGB) aerial image of the area and a multispectral aerial image of the area, the multispectral aerial image of the area containing image data in red, green, blue, red edge, and near-infrared bands;
detecting a plurality of plants in the area based on the RGB aerial image of the area;
determining a plurality of vegetation indices respectively corresponding to the plurality of plants based on the multispectral aerial image of the area; and
determining whether plant disease exists in the plurality of plants based on the vegetation indices and a disease threshold.

E2. The apparatus of E1, wherein the disease threshold is associated with at least one of:
a ratio of a green color to a non-green color in the plurality of plants,
a color of soil in the area, or
one or more properties of soil in the area.

E3. The apparatus of E1, wherein the vegetation indices include at least one of:
a plurality of normalized difference vegetation indices, or
a plurality of soil-adjusted vegetation indices.

E4. The apparatus of E1, wherein determining whether plant disease exists in the plurality of plants based on the vegetation indices and the disease threshold comprises:
determining that plant disease exists in one of the plurality of plants when one of the vegetation indices corresponding to the one of the plurality of plants is less than the disease threshold; or
determining that plant disease does not exist in the one of the plurality of plants when the one of vegetation indices corresponding to the one of the plurality of plants is equal to or greater than the disease threshold.

E5. The apparatus of E4, the operations further comprising:
responsive to a determination that plant disease exists in the one of the plurality of plants:
obtaining a side-view image of the one of the plurality of plants; and
determining whether the plant disease is Ganoderma disease based on the side-view image.

E6. The apparatus of E5, wherein determining whether the plant disease is Ganoderma disease based on the side-view image comprises:
determining that plant disease is Ganoderma disease when the side-view image contains at least one of:
a skirt-like crown of leaves,
a mycelium,
a fruiting body,
a drooping frond, or
a rotting trunk.

E7. The apparatus of E1, wherein determining the plurality of vegetation indices corresponding to the plurality of plants based on the multispectral aerial image of the area comprises:
determining one of the vegetation indices corresponding to one of the plurality of plants based on an average vegetation index of a first number of pixels in the multispectral aerial image of the area, wherein:
the one of the plurality of plants spans a second number of pixels in the multispectral aerial image of the area, and
the first number of pixels are a part of the second number of pixels.

E8. The apparatus of E1, wherein the disease threshold is a first disease threshold, the operations further comprising:
identifying one of the plurality of plants with a vegetation index less than the first disease threshold and greater than a second disease threshold, the first disease threshold being greater than the second disease threshold;
obtaining a side-view image of the one of the plurality of plants; and
determining whether plant disease exists in the one of the plurality of plants based on the side-view image.

E9. The apparatus of E1, wherein the disease threshold is a first disease threshold, the operations further comprising:
identifying one of the plurality of plants with a vegetation index less than the first disease threshold and greater than a second disease threshold, the first disease threshold being greater than the second disease threshold;
obtaining a value of chlorophyll b content in a leaf of the one of the plurality of plants; and
determining whether plant disease exists in the one of the plurality of plants based on the value of chlorophyll b content and a third disease threshold.

E10. The apparatus of E1, wherein the disease threshold is a first disease threshold, the operations further comprising:
identifying one of the plurality of plants with a vegetation index less than the first disease threshold and greater than a second disease threshold, the first disease threshold being greater than the second disease threshold;
obtaining a multispectral aerial image of a healthy plant; and
determining whether plant disease exists in the one of the plurality of plants based on the multispectral aerial image of the healthy plant and the multispectral aerial image of the area.

E11. The apparatus of E1, the operations further comprising:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

E12. A non-transitory computer-readable medium storing instructions which, when executed, cause one or more processors to perform operations for detecting plant disease in an area, the operations comprising:
obtaining a red-green-blue (RGB) aerial image of the area and a multispectral aerial image of the area, the multispectral aerial image of the area containing image data in red, green, blue, red edge, and near-infrared bands;
detecting a plurality of plants in the area based on the RGB aerial image of the area;
determining a plurality of vegetation indices respectively corresponding to the plurality of plants based on the multispectral aerial image of the area; and
determining whether plant disease exists in the plurality of plants based on the vegetation indices and a disease threshold.

E13. The non-transitory computer-readable medium of E12, wherein the disease threshold is associated with at least one of:
a ratio of a green color to a non-green color in the plurality of plants,
a color of soil in the area, or
one or more properties of soil in the area.

E14. The non-transitory computer-readable medium of E12, wherein determining whether plant disease exists in the plurality of plants based on the vegetation indices and the disease threshold comprises:
determining that plant disease exists in one of the plurality of plants when one of the vegetation indices corresponding to the one of the plurality of plants is less than the disease threshold; or
determining that plant disease does not exist in the one of the plurality of plants when the one of vegetation indices corresponding to the one of the plurality of plants is equal to or greater than the disease threshold.

E15. The non-transitory computer-readable medium of E14, the operations further comprising:
responsive to a determination that plant disease exists in the one of the plurality of plants:
obtaining a side-view image of the one of the plurality of plants; and
determining whether the plant disease is Ganoderma disease based on the side-view image.

E16. The non-transitory computer-readable medium of E15, wherein determining whether the plant disease is Ganoderma disease based on the side-view image comprises:
determining that plant disease is Ganoderma disease when the side-view image contains at least one of:
a skirt-like crown of leaves,
a mycelium,
a fruiting body,
a drooping frond, or
a rotting trunk.

E17. The non-transitory computer-readable medium of E12, wherein determining the plurality of vegetation indices corresponding to the plurality of plants based on the multispectral aerial image of the area comprises:

determining one of the vegetation indices corresponding to one of the plurality of plants based on an average vegetation index of a first number of pixels in the multispectral aerial image, wherein:
the one of the plurality of plants spans a second number of pixels in the multispectral aerial image, and
the first number of pixels are a part of the second number of pixels.

E18. The non-transitory computer-readable medium of E12, wherein the disease threshold is a first disease threshold, the operations further comprising:
identifying one of the plurality of plants with a vegetation index less than the first disease threshold and greater than a second disease threshold, the first disease threshold being greater than the second disease threshold;
obtaining a side-view image of the one of the plurality of plants; and
determining whether plant disease exists in the one of the plurality of plants based on the side-view image.

E19. The non-transitory computer-readable medium of E12, wherein the disease threshold is a first disease threshold, the operations further comprising:
identifying one of the plurality of plants with a vegetation index less than the first disease threshold and greater than a second disease threshold, the first disease threshold being greater than the second disease threshold;
obtaining a value of chlorophyll b content in a leaf of the one of the plurality of plants; and
determining whether plant disease exists in the one of the plurality of plants based on the value of chlorophyll b content and a third disease threshold.

E20. A method for detecting plant disease in an area, the method comprising:
obtaining a red-green-blue (RGB) aerial image of the area and a multispectral aerial image of the area, the multispectral aerial image containing image data in red, green, blue, red edge, and near-infrared bands;
detecting a plurality of plants in the area based on the RGB aerial image of the area;
determining a plurality of vegetation indices respectively corresponding to the plurality of plants based on the multispectral aerial image; and
determining whether plant disease exists in the plurality of plants based on the vegetation indices and a disease threshold.

E21. Apparatus for detecting plant disease in an area, the apparatus comprising: a memory storing instructions; and at least one processor configured to execute the instructions to perform operations comprising:
obtaining a plurality of side-view images corresponding to a plurality of plants;
obtaining one or more template images of one or more sample plants; and
determining whether plant disease exists in the plurality of plants based on the side-view images and the one or more template images.

E22. The apparatus of E21, wherein determining whether plant disease exists in the plurality of plants based on the side-view images and the one or more template images comprises:
calculating a plurality of match rates between the side-view images and the one or more template images; and
determining whether plant disease exists in the plurality of plants based on the match rates and a match threshold.

E23. The apparatus of E22, wherein determining whether plant disease exists in the plurality of plants based on the match rates and the match threshold comprises:
determining that plant disease exists in one of the plurality of plants when one of the match rates corresponding to the one of the plurality of plants is less than the match threshold; or
determining that plant disease does not exist in the one of the plurality of plants when the one of match rates is equal to or greater than the match threshold.

E24. The apparatus of E21, wherein determining whether plant disease exists in the plurality of plants based on the side-view images and the one or more template images comprises:
determining that plant disease exists in one of the plurality of plants when one of the side-view images corresponding to the one of the plurality of plants contains at least one of:
a skirt-like crown of leaves,
a mycelium,
a fruiting body,
a drooping frond, or
a rotting trunk.

E25. The apparatus of E22, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining image data in red, green, blue, red edge, and near-infrared bands, corresponding to the one of the plurality of plants;
determining a vegetation index based on the image data; and
determining whether plant disease exists in the one of the plurality of plants based on the vegetation index and a disease threshold.

E26. The apparatus of E22, wherein:
the match rates correspond to the plurality of plants;
the one or more template images are one or more first template images and the one or more sample plants are first sample plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a multispectral aerial image corresponding to the one of the plurality of plants;
obtaining one or more second template images of one or more second sample plants; and
determining whether plant disease exists in the one of the plurality of plants based on the multispectral aerial image and the one or more second template images.

E27. The apparatus of E22, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a value of chlorophyll b content in a leaf of the one of the plurality of plants; and
determining whether plant disease exists in the one of the plurality of plants based on the value of chlorophyll b content and a disease threshold.

E28. The apparatus of E21, wherein the operations further comprise:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

E29. A non-transitory computer-readable medium storing instructions which, when executed, cause one or more processors to perform operations for detecting plant disease in an area, the operations comprising:
obtaining a plurality of side-view images corresponding to a plurality of plants;
obtaining one or more template images of one or more sample plants; and
determining whether plant disease exists in the plurality of plants based on the side-view images and the one or more template images.

E30. The non-transitory computer-readable medium of E29, wherein determining whether plant disease exists in the plurality of plants based on the side-view images and the one or more template images comprises:
calculating a plurality of match rates between the side-view images and the one or more template images; and
determining whether plant disease exists in the plurality of plants based on the match rates and a match threshold.

E31. The non-transitory computer-readable medium of E30, wherein determining whether plant disease exists in the plurality of plants based on the match rates and the match threshold comprises:
determining that plant disease exists in one of the plurality of plants when one of the match rates corresponding to the one of the plurality of plants is less than the match threshold; or
determining that plant disease does not exist in the one of the plurality of plants when the one of match rates is equal to or greater than the match threshold.

E32. The non-transitory computer-readable medium of E29, wherein determining whether plant disease exists in the plurality of plants based on the side-view images and the one or more template images comprises:
determining that plant disease exists in one of the plurality of plants when one of the side-view images corresponding to the one of the plurality of plants contains at least one of:
a skirt-like crown of leaves,
a mycelium,
a fruiting body,
a drooping frond, or
a rotting trunk.

E33. The non-transitory computer-readable medium of E30, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining image data in red, green, blue, red edge, and near-infrared bands, corresponding to the one of the plurality of plants;
determining a vegetation index based on the image data; and
determining whether plant disease exists in the one of the plurality of plants based on the vegetation index and a disease threshold.

E34. The non-transitory computer-readable medium of E30, wherein:
the match rates correspond to the plurality of plants;
the one or more template images are one or more first template images and the one or more sample plants are first sample plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a multispectral aerial image corresponding to the one of the plurality of plants;
obtaining one or more second template images of one or more second sample plants; and
determining whether plant disease exists in the one of the plurality of plants based on the multispectral aerial image and the one or more second template images.

E35. The non-transitory computer-readable medium of E30, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a value of chlorophyll b content in a leaf of the one of the plurality of plants; and
determining whether plant disease exists in the one of the plurality of plants based on the value of chlorophyll b content and a disease threshold.

E36. The non-transitory computer-readable medium of E29, the operations further comprising:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

E37. A method for detecting plant disease in an area, the method comprising:
obtaining a plurality of side-view images corresponding to a plurality of plants;
obtaining one or more template images of one or more sample plants; and
determining whether plant disease exists in the plurality of plants based on the side-view images and the one or more template images.

E38. The method of E37, wherein determining whether plant disease exists in the plurality of plants based on the side-view images and the one or more template images comprises:
calculating a plurality of match rates between the side-view images and the one or more template images; and
determining whether plant disease exists in the plurality of plants based on the match rates and a match threshold.

E39. The method of E38, wherein determining whether plant disease exists in the plurality of plants based on the match rates and the match threshold comprises:
determining that plant disease exists in one of the plurality of plants when one of the match rates corresponding to the one of the plurality of plants is less than the match threshold; or
determining that plant disease does not exist in the one of the plurality of plants when the one of match rates is equal to or greater than the match threshold.

E40. The method of E37, wherein determining whether plant disease exists in the plurality of plants based on the side-view images and the one or more template images comprises:
determining that plant disease exists in one of the plurality of plants when one of the side-view images corresponding to the one of the plurality of plants contains at least one of:
a skirt-like crown of leaves,
a mycelium,
a fruiting body,
a drooping frond, or
a rotting trunk.

E41. Apparatus for detecting plant disease in an area, the apparatus comprising: a memory storing instructions; and at least one processor configured to execute the instructions to perform operations comprising:
obtaining a plurality of values of chlorophyll b contents in leaves of a plurality of plants; and
determining whether plant disease exists in the plurality of plants based on the values of chlorophyll b contents and a disease threshold.

E42. The apparatus of E41, wherein determining whether plant disease exists in the plurality of plants based on the values of chlorophyll b contents and the disease threshold comprises:
determining that plant disease exists in one of the plurality of plants when one of the values of chlorophyll b contents corresponding to the one of the plurality of plants is less than the disease threshold; or
determining that plant disease does not exist in the one of the plurality of plants when the one of the values of chlorophyll b contents is equal to or greater than the disease threshold.

E43. The apparatus of E42, the operations further comprising:
responsive to a determination that plant disease exists in the one of the plurality of plants,
obtaining a side-view image of the one of the plurality of plants; and
determining whether the plant disease is Ganoderma disease based on the side-view image.

E44. The apparatus of E43, wherein determining whether the plant disease is Ganoderma disease based on the side-view image comprises:
determining that plant disease is Ganoderma disease when the side-view image contains at least one of:
a skirt-like crown of leaves,
a mycelium,
a fruiting body,
a drooping frond, or
a rotting trunk.

E45. The apparatus of E41, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining a side-view image of the one of the plurality of plants; and
determining whether plant disease exists in the one of the plurality of plants based on the side-view image.

E46. The apparatus of E41, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining image data in red, green, blue, red edge, and near-infrared bands, corresponding to the one of the plurality of plants;
determining a vegetation index based on the image data; and
determining whether plant disease exists in the one of the plurality of plants based on the vegetation index and a third disease threshold.

E47. The apparatus of E41, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining a multispectral aerial image corresponding to the one of the plurality of plants;
obtaining one or more template images of one or more sample plants; and
determining whether plant disease exists in the one of the plurality of plants based on the multispectral aerial image and the one or more template images.

E48. The apparatus of E41, wherein the operations further comprise:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

E49. A non-transitory computer-readable medium storing instructions which, when executed, cause one or more processors to perform operations for detecting plant disease in an area, the operations comprising:
obtaining a plurality of values of chlorophyll b contents in leaves of a plurality of plants; and
determining whether plant disease exists in the plurality of plants based on the values of chlorophyll b contents and a disease threshold.

E50. The non-transitory computer-readable medium of E49, wherein determining whether plant disease exists in the plurality of plants based on the values of chlorophyll b contents and the disease threshold comprises:
determining that plant disease exists in one of the plurality of plants when one of the values of chlorophyll b contents corresponding to the one of the plurality of plants is less than the disease threshold; or
determining that plant disease does not exist in the one of the plurality of plants when the one of the values of chlorophyll b contents is equal to or greater than the disease threshold.

E51. The non-transitory computer-readable medium of E50, the operations further comprising:
responsive to a determination that plant disease exists in the one of the plurality of plants,
obtaining a side-view image of the one of the plurality of plants; and
determining whether the plant disease is Ganoderma disease based on the side-view image.

E52. The non-transitory computer-readable medium of E51, wherein determining whether the plant disease is Ganoderma disease based on the side-view image comprises:
determining that plant disease is Ganoderma disease when the side-view image contains at least one of:
a skirt-like crown of leaves,
a mycelium,
a fruiting body,
a drooping frond, or
a rotting trunk.

E53. The non-transitory computer-readable medium of E49, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining a side-view image of the one of the plurality of plants; and
determining whether plant disease exists in the one of the plurality of plants based on the side-view image.

E54. The non-transitory computer-readable medium of E49, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining image data in red, green, blue, red edge, and near-infrared bands, corresponding to the one of the plurality of plants;
determining a vegetation index based on the image data; and
determining whether plant disease exists in the one of the plurality of plants based on the vegetation index and a third disease threshold.

E55. The non-transitory computer-readable medium of E49, wherein:
the values of chlorophyll b contents correspond to the plurality of plants;
the disease threshold is a first disease threshold; and
the operations further comprise:
identifying one of the plurality of plants corresponding to one of the values of chlorophyll b content less than the first disease threshold and equal to or greater than a second disease threshold, the second disease threshold being less than the first disease threshold;
obtaining a multispectral aerial image corresponding to the one of the plurality of plants;
obtaining one or more template images of one or more sample plants; and
determining whether plant disease exists in the one of the plurality of plants based on the multispectral aerial image and the one or more template images.

E56. The non-transitory computer-readable medium of E49, wherein the operations further comprise:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

E57. A method for detecting plant disease in an area, the method comprising:
obtaining a plurality of values of chlorophyll b contents in leaves of a plurality of plants; and
determining whether plant disease exists in the plurality of plants based on the values of chlorophyll b contents and a disease threshold.

E58. The method of E57, wherein determining whether plant disease exists in the plurality of plants based on the values of chlorophyll b contents and the disease threshold comprises:
determining that plant disease exists in one of the plurality of plants when one of the values of chlorophyll b contents corresponding to the one of the plurality of plants is less than the disease threshold; or
determining that plant disease does not exist in the one of the plurality of plants when the one of the values of chlorophyll b contents is equal to or greater than the disease threshold.

E59. The method of E58, the operations further comprising:
responsive to a determination that plant disease exists in the one of the plurality of plants,
obtaining a side-view image of the one of the plurality of plants; and
determining whether the plant disease is Ganoderma disease based on the side-view image.

E60. The method of E59, wherein determining whether the plant disease is Ganoderma disease based on the side-view image comprises:
determining that plant disease is Ganoderma disease when the side-view image contains at least one of:
a skirt-like crown of leaves,
a mycelium,
a fruiting body,
a drooping frond, or
a rotting trunk.

It will be appreciated that the present disclosure is not limited to the exact construction that has been described above and illustrated in the accompanying drawings, and that various modifications and changes can be made without departing from the scope thereof. It is intended that the scope of the application should only be limited by the appended claims.

1. Apparatus for detecting plant disease in an area, the apparatus comprising:
a memory storing instructions; and
at least one processor configured to execute the instructions to perform operations comprising:
obtaining a plurality of multispectral aerial images corresponding to a plurality of plants;
obtaining one or more template images of one or more sample plants; and
determining whether plant disease exists in the plurality of plants based on the multispectral aerial images and the one or more template images.

2. The apparatus of claim 1, wherein the multispectral aerial images and the one or more template images are generated based on at least one of:
a plurality of normalized difference vegetation indices, or
a plurality of soil-adjusted vegetation indices.

3. The apparatus of claim 1, wherein determining whether plant disease exists in the plurality of plants based on the multispectral aerial images and the one or more template images comprises:
calculating a plurality of match rates between the multispectral aerial images and the one or more template images; and
determining whether plant disease exists in the plurality of plants based on the match rates and a match threshold.

4. The apparatus of claim 3, wherein determining whether plant disease exists in the plurality of plants based on the match rates and the match threshold comprises:
determining that plant disease exists in one of the plurality of plants when one of the match rates corresponding to the one of the plurality of plants is less than the match threshold; or
determining that plant disease does not exist in the one of the plurality of plants when the one of the match rates is equal to or greater than the match threshold.

5. The apparatus of claim 3, wherein:
the multispectral aerial images contain a plurality of image data in red, green, blue, red edge, and near-infrared bands;
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
determining a vegetation index corresponding to the one of the plurality of plants based on the image data corresponding to the one of the plurality of plants; and
determining whether plant disease exists in the one of the plurality of plants based on the vegetation index and a disease threshold.

6. The apparatus of claim 3, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a side-view image of the one of the plurality of plants; and
determining whether plant disease exists in the one of the plurality of plants based on the side-view image.

7. The apparatus of claim 6, wherein determining whether plant disease exists in the one of the plurality of plants based on the side-view image comprises:
determining that plant disease exists in the one of the plurality of plants when the side-view image contains at least one of:
a skirt-like crown of leaves,
a mycelium,
a fruiting body,
a drooping frond, or
a rotting trunk.

8. The apparatus of claim 3, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a value of chlorophyll b content in a leaf of the one of the plurality of plants; and
determining whether plant disease exists in the one of the plurality of plants based on the value of chlorophyll b content and a disease threshold.

9. The apparatus of claim 1, the operations further comprising:
generating an indication of the plant disease in response to a determination that plant disease exists in at least one of the plurality of plants,
wherein the indication includes information about:
the plant disease existing in at least one of the plurality of plants, and
which one of the plurality of plants having the plant disease.

10. A non-transitory computer-readable medium storing instructions which, when executed, cause one or more processors to perform operations for detecting plant disease in an area, the operations comprising:
obtaining a plurality of multispectral aerial images corresponding to a plurality of plants;
obtaining one or more template images of one or more sample plants; and
determining whether plant disease exists in the plurality of plants based on the multispectral aerial images and the one or more template images.

11. The non-transitory computer-readable medium of claim 10, wherein the multispectral aerial images and the one or more template images are generated based on at least one of:
a plurality of normalized difference vegetation indices, or
a plurality of soil-adjusted vegetation indices.

12. The non-transitory computer-readable medium of claim 10, wherein determining whether plant disease exists in the plurality of plants based on the multispectral aerial images and the one or more template images comprises:
calculating a plurality of match rates between the multispectral aerial images and the one or more template images; and
determining whether plant disease exists in the plurality of plants based on the match rates and a match threshold.

13. The non-transitory computer-readable medium of claim 12, wherein determining whether plant disease exists in the plurality of plants based on the match rates and the match threshold comprises:
determining that plant disease exists in one of the plurality of plants when one of the match rates corresponding to the one of the plurality of plants is less than the match threshold; or
determining that plant disease does not exist in the one of the plurality of plants when the one of the match rates is equal to or greater than the match threshold.

14. The non-transitory computer-readable medium of claim 12, wherein:
the multispectral aerial images contain a plurality of image data in red, green, blue, red edge, and near-infrared bands;
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
determining a vegetation index corresponding to the one of the plurality of plants based on the image data corresponding to the one of the plurality of plants; and
determining whether plant disease exists in the one of the plurality of plants based on the vegetation index and a disease threshold.

15. The non-transitory computer-readable medium of claim 12, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a side-view image of the one of the plurality of plants; and
determining whether plant disease exists in the one of the plurality of plants based on the side-view image.

16. The non-transitory computer-readable medium of claim 15, wherein determining whether plant disease exists in the one of the plurality of plants based on the side-view image comprises:
determining that plant disease exists in the one of the plurality of plants when the side-view image contains at least one of:
a skirt-like crown of leaves,
a mycelium,
a fruiting body,
a drooping frond, or
a rotting trunk.

17. The non-transitory computer-readable medium of claim 12, wherein:
the match rates correspond to the plurality of plants;
the match threshold is a first match threshold; and
the operations further comprise:
identifying one of the plurality of plants corresponding to one of the match rates less than the first match threshold and equal to or greater than a second match threshold, the second match threshold being less than the first match threshold;
obtaining a value of chlorophyll b content in a leaf of the one of the plurality of plants; and
determining whether plant disease exists in the one of the plurality of plants based on the value of chlorophyll b content and a disease threshold.

18. The non-transitory computer-readable medium of claim 10, the operations further comprising:
generating an indication of the plant disease in response to a determination that plant disease exists in at least one of the plurality of plants,
wherein the indication includes information about:
the plant disease existing in at least one of the plurality of plants, and
which one of the plurality of plants has the plant disease.

19. A method for detecting plant disease in an area, the method comprising:
obtaining a plurality of multispectral aerial images corresponding to a plurality of plants;
obtaining one or more template images of one or more sample plants; and
determining whether plant disease exists in the plurality of plants based on the multispectral aerial images and the one or more template images.

20. The method of claim 19, wherein determining whether plant disease exists in the plurality of plants based on the multispectral aerial images and the one or more template images comprises:
calculating a plurality of match rates between the multispectral aerial images and the one or more template images; and
determining whether plant disease exists in the plurality of plants based on the match rates and a match threshold.
